(19) United States
(12) Patent Application Publication
(10) Pub. No.: US 2026/0193538 A1
(43) Pub. Date: Jul. 9, 2026

(54) SYNERGISTIC POLYMER BLEND DISPERSANTS, DISPERSANT CONCENTRATES, CONDUCTIVE CARBON DISPERSIONS, AND ELECTRODE SLURRY COMPOSITIONS, AND METHODS OF MAKING AND USE THEREOF

(71) Applicant: Infineum International Limited, Linden, NJ (US)

(72) Inventors: Gang Hu, Scotch Plains, NJ (US); Chee Ling Tong, Springfield, NJ (US); James Beament, Wantage (GB)

(73) Assignee: Infineum International Limited, Linden, NJ (US)

(21) Appl. No.: 19/417,782

(22) Filed: Dec. 12, 2025

Related U.S. Application Data
(60) Provisional application No. 63/733,549, filed on Dec. 13, 2024.

(51) Int. Cl. C09K 23/00; C08K 5/07; C08L 25/18; C08L 33/18; H01M 4/02; H01M 4/04; H01M 4/58; H01M 4/62

(52) U.S. Cl. CPC C09K 23/017; C08K 5/07; C08L 25/18; C08L 33/18; H01M 4/0404; H01M 4/5825; H01M 4/625; C08L 2203/20; H01M 2004/021; H01M 2004/028

(57) ABSTRACT

Polymer blends having an organic nitrile-based copolymer, and a phenol-based polymer or a phenol-based copolymer. The organic nitrile-based copolymer has structural units comprising the residue of a substituted or unsubstituted, unsaturated organic nitrile monomer, and structural units comprising the residue of a substituted or unsubstituted, conjugated diene monomer. The phenol-based polymer has structural units comprising the residue of a substituted or unsubstituted, unsaturated phenolic monomer. The phenol-based copolymer has structural units comprising the residue of a substituted or unsubstituted, unsaturated coupled phenolic resin. The organic nitrile-based copolymer is present in an amount from about 0.5 wt % to about 99.5 wt %, and the phenol-based polymer, or the phenol-based copolymer, is present in an amount from about 0.5 wt % to about 99.5 wt %, based on the total weight of the polymer blend. The polymer blends are effective as synergistic dispersants.

### CROSS-REFERENCE TO RELATED APPLICATION

This U.S. Non-provisional application claims priority to U.S. Provisional Application Ser. No. 63/733,549 filed on Dec. 13, 2024, the contents of which are herein incorporated by reference in their entirety.

### FIELD

This disclosure relates to polymer blends that are effective as synergistic dispersants. This disclosure also relates to dispersant concentrates, conductive carbon dispersions, and electrode slurry compositions. This disclosure further relates to positive electrodes, and electrical storage devices, that use the electrode slurry compositions disclosed herein.

### BACKGROUND

A secondary battery is a battery which may be repeatedly used through a discharging process in which chemical energy is converted into electrical energy and a charging process in the reverse direction thereof. The secondary battery is composed of a positive electrode, a negative electrode, an electrolyte, and a separator. In general, the positive electrode and the negative electrode are composed of an electrode current collector and an electrode active material layer formed on the electrode current collector. The electrode active material layer is prepared by applying an electrode slurry composition including an electrode active material, a conductive material, a binder, a solvent, and the like on the electrode current collector, followed by drying, and then roll-pressing.

The manufacturing process for a secondary lithium-ion battery (LiB) cathode requires casting a cathode slurry uniformly onto a metal current collector (typically aluminum sheet) as the first step. Cathode slurry is typically a composition of battery active materials (AM), conductive carbon (CC), and binder (polyvinylidene fluoride, PVDF), mixed in solvent (typically N-methyl pyrrolidone, NMP). To achieve high battery capacity and long cycling life, it is critical to ensure that AM and CC agglomerates in raw materials are broken down into small particles uniformly, and stably dispersed in cathode slurry with desired rheological properties for coating.

To that end, a wetting and dispersing agent is added in the composition to expediate and stabilize the dispersion of AM and CC in a cathode slurry, and thus achieve desired physical properties. Moreover, as the solvent NMP is evaporated and removed under heat and vacuum, and then recycled immediately after coating, high-solid content (total of non-volatiles), or less-solvent slurry is highly desired (like 65 wt %) to reduce cycle time and operational cost. Therefore, there is a great need in the battery industry to achieve a high-solid content slurry while still maintain desired dispersion and rheological properties.

On the other hand, carbon nanotubes (CNTs) are replacing carbon black (CB) as conductive carbon in cathode slurry composition to improve electrode conductivity among AM particles, due to CNT's very high aspect ratio (length/diameter ratio). However, also due to the high aspect ratio, CNTs are very difficult to disperse in a medium, especially at a high CNT treat rate. Usually, CNTs are pre-dispersed in a solvent to form CNT dispersion which is then mixed with other components of cathode composition to form cathode slurry. In that process, a wetting and dispersing agent can also be added to aid and stabilize CNT dispersion in NMP, ideally at a high CNT content.

Polyvinylpyrrolidone (PVP) is widely used as a dispersant, and recognized as an industry benchmark dispersant. However, PVP suffers from low dispersing efficiency and side reactions of decomposition in battery operation, especially at high voltage. Additionally, the viscosity of a conductive material dispersion using a PVP dispersant increases rapidly when the content of a conductive material increases and with prolonged storage time. So there is a limit to increasing the content of the conductive material or active material.

It would be advantageous to provide dispersants that are more electrochemically stable and more efficient than the industry benchmark PVP dispersant. Also, it would be advantageous to provide dispersants that achieve lower viscosity of a CNT dispersion, or a cathode slurry composition, than viscosity achieved with the industry benchmark PVP dispersant, at constant solid content, or increase solid content of the CNT dispersion or cathode slurry composition, at constant viscosity.

### SUMMARY

In accordance with an aspect of the present disclosure, there is provided polymer blends that are effective as synergistic dispersants. The polymer blend synergistic dispersants are more stable and more efficient than the industry benchmark PVP dispersant. The polymer blend synergistic dispersants achieve lower viscosity of a CNT dispersion, or a lithium iron phosphate (LFP) cathode slurry composition, than viscosity achieved with the industry benchmark PVP dispersant, at constant solid content, or increase solid content of the CNT dispersion or cathode slurry composition, at constant viscosity.

The polymer blends of the present disclosure comprise an organic nitrile-based copolymer, and a phenol-based polymer or a phenol-based copolymer. The organic nitrile-based copolymer comprises structural units comprising the residue of a substituted or unsubstituted, unsaturated organic nitrile monomer; and structural units comprising the residue of a substituted or unsubstituted, conjugated diene monomer. The phenol-based polymer comprises structural units comprising the residue of a substituted or unsubstituted, unsaturated phenolic monomer. The phenol-based copolymer comprises structural units comprising the residue of a substituted or unsubstituted, unsaturated coupled phenolic resin. The organic nitrile-based copolymer is present in an amount from about 0.5 wt % to about 99.5 wt %, and the phenol-based polymer, or the phenol-based copolymer, is present in an amount from about 0.5 wt % to about 99.5 wt %, based on the total weight of the polymer blend.

The polymer blends of this disclosure are effective as synergistic dispersants. When the synergistic dispersant is present in a conductive carbon dispersion, the conductive carbon dispersion exhibits lower viscosity as compared to a conductive carbon dispersion in which only the organic nitrile-based copolymer, or the phenol-based polymer, or the phenol-based copolymer, is present. When the synergistic dispersant is present in an electrode slurry composition, the electrode slurry composition exhibits lower viscosity as compared to an electrode slurry composition in which only the organic nitrile-based copolymer, or the phenol-based polymer, or the phenol-based copolymer, is present.

Additionally or alternatively, the present disclosure provides a dispersant concentrate comprising a polymer blend synergistic dispersant, and a solvent.

Additionally or alternatively, the present disclosure provides a conductive carbon dispersion comprising the polymer blend synergistic dispersant, or the dispersant concentrate, a conductive carbon, and a solvent.

Further additionally or alternatively, the present disclosure provides an electrode slurry composition for producing a battery positive electrode comprising the conductive carbon dispersion, an electrode active material, and a binder.

Further additionally or alternatively, the present disclosure provides a positive electrode comprising an electrical current collector and a film formed on the electrical current collector, wherein the film is deposited from the electrode slurry composition, and the solvent subsequently removed.

Further additionally or alternatively, the present disclosure provides an electrical storage device comprising the positive electrode, a negative electrode, a separator, and an electrolyte.

It has been surprisingly found that, in accordance with this disclosure, a dispersant having a combination or blend of an organic nitrile-based copolymer, and a phenol-based polymer or a phenol-based copolymer, improves the rheological properties of a CNT dispersion, more than use of either polymer or copolymer dispersant alone. This synergistic effect can be used to achieve lower viscosity of the dispersion than industry benchmark polyvinylpyrrolidone (PVP) at constant solid content, or increase solid content of the dispersion at constant viscosity.

Also, it has been surprisingly found that, in accordance with this disclosure, that a dispersant having a combination or blend of an organic nitrile-based copolymer, and a phenol-based polymer or a phenol-based copolymer, can be used in LFP cathode slurry compositions to achieve lower viscosity, than using either polymer or copolymer dispersant alone. Lower viscosity was achieved with the dispersant combination or blend of an organic nitrile-based copolymer, and a phenol-based polymer or a phenol-based copolymer, than viscosity achieved with the industry benchmark PVP dispersant, at high solid content.

Further, it has been surprisingly found that, in accordance with this disclosure, the polymer blend synergistic dispersants achieve lower viscosity of a CNT dispersion, than viscosity achieved with the industry benchmark PVP dispersant, at constant solid content, or increase solid content of the CNT dispersion, at constant viscosity, thereby making the polymer blend synergistic dispersants attractive for use in CNT dispersion formulations for LiB manufacturers.

Yet further, it has been surprisingly found that, in accordance with this disclosure, the polymer blend synergistic dispersants can be used in LFP cathode slurry formulations to achieve lower viscosity than industry benchmark PVP dispersant at high solid content, thereby making the polymer blend synergistic dispersants attractive for LiB manufacturer's LFP cathode slurry formulations.

### BRIEF DESCRIPTION OF THE DRAWINGS

FIG. 1 graphically depicts a comparison of rheology of CNT dispersions using different dispersants in Table E, particularly viscosity relative to shear rate for comparative and inventive dispersants in Table E below in CNT dispersions, in accordance with the Examples.

FIG. 2 graphically depicts a comparison of the rheology of LFP cathode slurries using different dispersants in Table F, particularly viscosity relative to shear rate for comparative and inventive dispersants in Table F below in LFP cathode slurries, in accordance with the Examples.

### DETAILED DESCRIPTION

The term “about” means approximately, which includes values obtain by rounding. As used herein, the term “about” modifying the quantity of an ingredient, component, or reactant of the invention employed refers to variation in the numerical quantity that can occur, for example, through typical measuring and liquid handling procedures used for making concentrates or lubricating oil compositions. Furthermore, variation can occur from inadvertent error in measuring procedures, differences in the manufacture, source, or purity of the ingredients employed to make the compositions or carry out the methods, and the like. In one aspect, the term “about” means within 10% of the reported numerical value. In another aspect, the term “about” means within 5% of the reported numerical value. Yet, in another aspect, the term “about” means within 10, 9, 8, 7, 6, 5, 4, 3, 2, or 1% of the reported numerical value. All numerical values included in the specification and the claims are understood to be modified by “about” even if such numerical value is not preceded by “about.”

This disclosure relates to polymer blends that are effective as synergistic dispersants. This disclosure also relates to dispersant concentrates, conductive carbon dispersions, electrode slurry compositions, positive electrodes, and electrical storage devices, using the synergistic dispersants.

### Polymer Blends

The polymer blends of the present disclosure comprise an organic nitrile-based copolymer, and a phenol-based polymer or a phenol-based copolymer. The organic nitrile-based copolymer comprises structural units comprising the residue of a substituted or unsubstituted, unsaturated organic nitrile monomer; and structural units comprising the residue of a substituted or unsubstituted, conjugated diene monomer. The copolymer may be then hydrogenated or maintained in an unhydrogenated form. The phenol-based polymer comprises structural units comprising the residue of a substituted or unsubstituted, unsaturated phenolic monomer. The phenol-based copolymer comprises structural units comprising the residue of a substituted or unsubstituted, unsaturated coupled phenolic resin. The organic nitrile-based copolymer is present in an amount from about 0.5 wt % to about 99.5 wt %, and the phenol-based polymer, or the phenol-based copolymer, is present in an amount from about 0.5 wt % to about 99.5 wt %, based on the total weight of the polymer blend

In an embodiment, the polymer blend can be an organic nitrile-based copolymer/phenol-based polymer blend or an organic nitrile-based copolymer/phenol-based copolymer blend.

The organic nitrile-based copolymer can be in the form of a block copolymer, a random copolymer, or a gradient copolymer.

In an embodiment, the substituted or unsubstituted, unsaturated organic nitrile monomer can be substituted or unsubstituted acrylonitrile monomer. Preferably, the substituted or unsubstituted, unsaturated organic nitrile monomer can be represented by the formula:

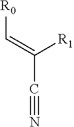

wherein R₀, R₁ is independently a hydrogen or an alkyl group having from 1 to 10 carbon atoms, preferably R₀, R₁ is hydrogen.

In an embodiment, the substituted or unsubstituted, conjugated diene monomer can be a substituted or unsubstituted butadiene monomer, represented by the formula:

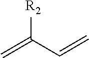

wherein R₂ is hydrogen or methyl.

In an embodiment, the organic nitrile-based copolymer comprises structural units of the residue of acrylonitrile and structural units of the residue of butadiene, and is represented by the formula:

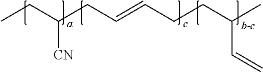

wherein a is a value from 100 to 800, b is a value from 200 to 1200, and c is a value from 0 to 1200. The structural units of the residue of acrylonitrile are present in an amount from about 10 wt % to about 60 wt %, based on the total weight of the organic nitrile-based copolymer.

In an embodiment, after hydrogenation, the organic nitrile-based copolymer is represented by the formula:

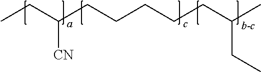

wherein a is a value from 100 to 800, b is a value from 200 to 1200, and c is a value from 0 to 1200; and
wherein the structural units of the residue of acrylonitrile are present in an amount from about 10 wt % to about 60 wt %, based on the total weight of the organic nitrile-based copolymer.

The phenol-based polymer can be a phenolic homopolymer represented by the formula:

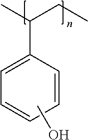

wherein n is a value from about 5 to about 2000.

In an embodiment, the phenol-based copolymer can be a coupled phenolic resin represented by the formula:

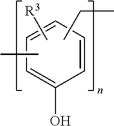

wherein R₃ is hydrogen or an alkyl group having from 1 to 20 carbon atoms, and n is a value from 5 to 2000.

In an embodiment, the coupled phenolic resin can be a substituted or unsubstituted phenolic compound coupled with a coupling agent.

The phenolic compound can be, for example, phenol, p-cresol, p-tert-butyl phenol, salicyl alcohol, p-nonyl phenol.

The coupling agent can be, for example, a substituted or unsubstituted aldehyde, sulfur, silane, or combinations thereof. Preferably, the coupling agent is a substituted or unsubstituted aldehyde is represented by the formula

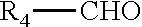

wherein R₄ is hydrogen or an alkyl group having from 1 to about 10 carbon atoms. More preferably, the coupling agent is formaldehyde.

The molar coupling ratio of the coupling agent to the phenolic compound, is from about 1.2:1 to about 0.8:1. Preferably, the coupling ratio of the coupling agent to the phenolic compound is 1:1.

In an embodiment, the phenol-based polymer is a phenolic homopolymer, and the phenol-based copolymer is a coupled phenolic resin.

In the polymer blends of this disclosure, the organic nitrile-based copolymer can be present in an amount from about 1 wt % to about 99 wt %, or from about 1 wt % to about 90 wt %, or from about 1 wt % to about 80 wt %, or from about 1 wt % to about 70 wt %, or from about 1 wt % to about 60 wt %, or from about 1 wt % to about 50 wt %, or from about 1 wt % to about 40 wt %, or from about 1 wt % to about 30 wt %, or from about 1 wt % to about 20 wt %, or from about 1 wt % to about 10 wt %, based on the total weight of the polymer blend.

In the polymer blends of this disclosure, the phenol-based polymer, or phenol-based copolymer, can be present in an amount from about 1 wt % to about 99 wt %, or from about 1 wt % to about 90 wt %, or from about 1 wt % to about 80 wt %, or from about 1 wt % to about 70 wt %, or from about 1 wt % to about 60 wt %, or from about 1 wt % to about 50 wt %, or from about 1 wt % to about 40 wt %, or from about 1 wt % to about 30 wt %, or from about 1 wt % to about 20 wt %, or from about 1 wt % to about 10 wt %, based on the total weight of the polymer blend.

In the polymer blends of this disclosure, the weight ratio of the organic nitrile-based copolymer to the phenol-based polymer, or phenol-based copolymer, in the polymer blend is from about 1:99 to about 99:1, or from about 1:99 to about 90:10, or from about 1:99 to about 80:20, or from about 1:99 to about 70:30, or from about 1:99 to about 60:40, or from about 1:99 to about 50:50, or from about 1:99 to about 40:60, or from about 1:99 to about 30:70, or from about 1:99 to about 20:80, or from about 1:99 to about 10:90.

The structural units comprising the residue of a substituted or unsubstituted, unsaturated organic nitrile monomer are present in an amount from about 1 wt % to about 99 wt %, or from about 1 wt % to about 90 wt %, or from about 1 wt % to about 80 wt %, or from about 1 wt % to about 70 wt %, or from about 1 wt % to about 60 wt %, or from about 1 wt % to about 50 wt %, or from about 1 wt % to about 40 wt %, or from about 1 wt % to about 30 wt %, or from about 1 wt % to about 20 wt %, or from about 1 wt % to about 10 wt %, based on the total weight of the organic nitrile-based copolymer.

Preferably, the structural units comprising the residue of a substituted or unsubstituted, unsaturated organic nitrile monomer are present in an amount from about 25 wt % to about 50 wt %, or from about 30 wt % to about 45 wt %, or from about 30 wt % to about 40 wt %, based on the total weight of the organic nitrile-based copolymer.

The structural units comprising the residue of a substituted or unsubstituted, conjugated diene monomer are present in an amount from about 1 wt % to about 99 wt %, or from about 10 wt % to about 95 wt %, or from about 20 wt % to about 90 wt %, or from about 30 wt % to about 85 wt %, or from about 40 wt % to about 80 wt %, or from about 50 wt % to about 80 wt %, or from about 55 wt % to about 75 wt %, or from about 60 wt % to about 70 wt %, based on the total weight of the organic nitrile-based copolymer.

In an embodiment, the weight ratio of the structural units comprising the residue of a substituted or unsubstituted, unsaturated organic nitrile monomer to the structural units comprising the residue of a substituted or unsubstituted, conjugated diene monomer in the organic nitrile-based copolymer is from about 1:99 to about 99:1, or from about 1:99 to about 90:10, or from about 1:99 to about 80:20, or from about 1:99 to about 70:30, or from about 1:99 to about 60:40, or from about 1:99 to about 50:50, or from about 1:99 to about 40:60, or from about 1:99 to about 30:70, or from about 1:99 to about 20:80, or from about 1:99 to about 10:90.

The organic nitrile-based copolymer can have a density between about 0.5-2.0 g/cm³, or between about 0.5-1.5 g/cm³, or between about 0.5-1.25 g/cm³, or between about 0.75-1.0 g/cm³.

The organic nitrile-based copolymer can have a Mooney viscosity (ML1+4 at 100° C.) from about 30 to about 150, or from about 30 to about 100, or from about 30 to about 90, or from about 30 to about 80.

In an embodiment, after hydrogenation, residual unsaturation in the organic nitrile-based copolymer is from about 0.1% to about 5%, or from about 0.1% to about 4%, or from about 0.1% to about 3%, or from about 0.1% to about 2%, or from about 0.1% to about 1%.

The organic nitrile-based copolymer can have a weight average molecular weight of at least 50,000 g/mol, or at least 75,000 g/mol, or at least 100,000 g/mol, or least 150,000 g/mol, or least 175,000 g/mol, or least 200,000 g/mol, or least 250,000 g/mol. Preferably, the organic nitrile-based copolymer has a weight average molecular weight of no more than 300,000 g/mol, or no more than 290,000 g/mol, or no more than 280,000, or no more than 270,000 g/mol, or no more than 260,000 g/mol, or no more than 250,000 g/mol, or no more than 225,000 g/mol.

In an embodiment, the organic nitrile-based copolymer has a weight average molecular weight of 50,000 to 300,000 g/mol, or 50,000 to 275,000 g/mol, or 50,000 to 250,000 g/mol, or 50,000 to 225,000 g/mol, or 50,000 to 200,000 g/mol, or 100,000 to 300,000 g/mol, or 100,000 to 275,000 g/mol, or 100,000 to 250,000 g/mol, or 100,000 to 225,000 g/mol, or 100,000 to 200,000 g/mol, or 150,000 to 300,000 g/mol, or 150,000 to 275,000 g/mol, or 150,000 to 250,000 g/mol, or 150,000 to 225,000 g/mol, or 150,000 to 200,000 g/mol, or 175,000 to 300,000 g/mol, or 175,000 to 275,000 g/mol, or 175,000 to 250,000 g/mol, or 175,000 to 225,000 g/mol, or 175,000 to 200,000 g/mol. Preferably, the organic nitrile-based copolymer has a weight average molecular weight of from about 50,000 g/mol to about 200,000 g/mol.

The organic nitrile-based copolymer has a number average molecular weight of at least 30,000 g/mol, or at least 50,000 g/mol, or at least 75,000 g/mol, or at least 100,000 g/mol, or least 150,000 g/mol, or least 175,000 g/mol. Preferably, the organic nitrile-based copolymer has a number average molecular weight of no more than 500,000 g/mol, or no more than 400,000, or no more than 300,000 g/mol, or no more than 200,000 g/mol, or no more than 100,000 g/mol, or no more than 50,000 g/mol, or no more than 30,000 g/mol.

In an embodiment, the organic nitrile-based copolymer has a number average molecular weight of 25,000 to 475,000 g/mol, or 25,000 to 375,000 g/mol, or 25,000 to 275,000 g/mol, or 25,000 to 175,000 g/mol, or 25,000 to 75,000 g/mol, or 50,000 to 475,000 g/mol, or 50,000 to 375,000 g/mol, or 50,000 to 275,000 g/mol, or 50,000 to 175,000 g/mol, or 50,000 to 100,000 g/mol, or 75,000 to 275,000 g/mol, or 75,000 to 4705,000 g/mol, or 75,000 to 375,000 g/mol, or 75,000 to 275,000 g/mol, or 75,000 to 175,000 g/mol, or 75,000 to 125,000 g/mol, or 100,000 to 475,000 g/mol, or 100,000 to 375,000 g/mol, or 100,000 to 275,000 g/mol, or 100,000 to 175,000 g/mol, or 100,000 to 150,000 g/mol. Preferably, the organic nitrile-based copolymer has a number average molecular weight of from about 30,000 g/mol to about 500,000 g/mol.

The phenol-based polymer, or phenol-based copolymer, can have a weight average molecular weight of at least 1,000 g/mol, or least 5,000 g/mol, or least 10,000 g/mol, or least 15,000 g/mol, or least 20,000 g/mol, or least 25,000 g/mol.

In an embodiment, the phenol-based polymer, or phenol-based copolymer, has a weight average molecular weight of 1,000 to 100,000 g/mol, or 1,000 to 75,000 g/mol, or 1,000 to 50,000 g/mol, or 1,000 to 25,000 g/mol, or 1,000 to 10,000 g/mol, or 1,000 to 5,000 g/mol, or 1,500 to 100,000 g/mol, or 1,500 to 75,000 g/mol, or 1,500 to 50,000 g/mol, or 1,500 to 25,000 g/mol, or 1,500 to 10,000 g/mol, or 1,500 to 5,000 g/mol, or 2,000 to 100,000 g/mol, or 2,000 to 75,000 g/mol, or 2,000 to 50,000 g/mol, or 2,000 to 25,000 g/mol, or 2,000 to 10,000 g/mol, or 2,000 to 5,000 g/mol, or 1,000 to 30,000 g/mol, or 2,500 to 100,000 g/mol, or 2,500 to 75,000 g/mol, or 2,500 to 50,000 g/mol, or 2,500 to 25,000 g/mol, or 2,500 to 10,000 g/mol, or 2,500 to 5,000 g/mol. Preferably, the phenol-based polymer, or phenol-based copolymer, has a weight average molecular weight of from about 1000 g/mol to about 100,000 g/mol.

The phenol-based polymer, or phenol-based copolymer, has a number average molecular weight of at least 500 g/mol, or at least 750 g/mol, or at least 1,000 g/mol, or least 5,000 g/mol, or least 10,000 g/mol, or least 15,000 g/mol, or least 20,000 g/mol, or least 25,000 g/mol.

In an embodiment, the phenol-based polymer, or phenol-based copolymer, has a number average molecular weight of no more than 50,000 g/mol, or no more than 40,000 g/mol, or no more than 30,000, or no more than 25,000 g/mol, or no more than 20,000 g/mol, or no more than 15,000 g/mol, or no more than 10,000 g/mol.

The phenol-based polymer, or phenol-based copolymer, can have a number average molecular weight of 500 to 50,000, or 500 to 40,000 g/mol, or 500 to 25,000 g/mol, or 500 to 20,000 g/mol, or 500 to 15,000 g/mol, or 500 to 10,000 g/mol, or 500 to 5,000 g/mol, or 500 to 1,000 g/mol, or 750 to 50,000, or 750 to 40,000 g/mol, or 750 to 25,000 g/mol, or 750 to 20,000 g/mol, or 750 to 15,000 g/mol, or 750 to 10,000 g/mol, or 750 to 5,000 g/mol, or 750 to 1,000 g/mol, or 1,000 to 50,000, or 1,000 to 40,000 g/mol, or 1,000 to 25,000 g/mol, or 1,000 to 20,000 g/mol, or 1,000 to 15,000 g/mol, or 1,000 to 10,000 g/mol, or 1,000 to 5,000 g/mol, or 1,500 to 50,000, or 1,500 to 40,000 g/mol, or 1,500 to 25,000 g/mol, or 1,500 to 20,000 g/mol, or 1,500 to 15,000 g/mol, or 1,500 to 10,000 g/mol, or 1,500 to 5,000 g/mol. Preferably, the phenol-based polymer, or phenol-based copolymer, has a number average molecular weight of from about 500 g/mol to about 50,000 g/mol.

### Processes

The polymer blends of this disclosure can be prepared by mixing or blending using conventional methods known in the art. The mixing or blending may be performed by a typical mixing method, for example, by known means such as a stirrer, bead mill or high-pressure homogenizer, for example, by using a mixing device such as a homogenizer, a beads mill, a ball mill, a basket mill, an attrition mill, an all-purpose stirrer, a clear mixer, a spike mill, a TK mixer, or the like.

The organic nitrile-based copolymer, the phenol-based polymer, and the phenol-based copolymer are conventional materials known in the art, and many are commercially available. The organic nitrile-based copolymer, the phenol-based polymer, and the phenol-based copolymer can be prepared by conventional methods known in the art.

The organic nitrile-based copolymer (e.g., nitrile butadiene rubber (NBR)), and the phenol-based homopolymer (e.g., poly(4-vinylphenol) (PVPL)) may be prepared by free radical initiated solution polymerization techniques in which the polymerizable monomers are dissolved in an organic medium comprising a solvent or a mixture of solvents and polymerized in the presence of a free radical initiator until conversion is complete. The organic medium used to produce the copolymer may comprise any suitable organic solvent or mixture of solvents, including those discussed herein with respect to the organic medium.

Examples of free radical initiators are those which are soluble in the mixture of monomers such as azobisisobutyronitrile (AIBN), azobis(alpha, gamma-methylvaleronitrile), tertiary-butyl perbenzoate, tertiary-butyl peracetate, benzoyl peroxide, ditertiary-butyl peroxide, and tertiary amyl peroxy 2-ethylhexyl carbonate.

Optionally, a chain transfer agent which is soluble in the mixture of monomers such as alkyl mercaptans, for example, tertiary-dodecyl mercaptan; ketones such as methyl ethyl ketone, chlorohydrocarbons such as chloroform, or thiocarbonyl and nitroxide compounds can be used. A chain transfer agent provides control over the molecular weight to give products having required viscosity for various coating applications.

To prepare the organic nitrile-based copolymer (e.g., nitrile butadiene rubber (NBR)), the solvent may be first heated to reflux and the mixture of polymerizable monomers (e.g., acrylonitrile and butadiene) containing the free radical initiator may be added slowly to the refluxing solvent. The reaction mixture is then held at polymerizing temperatures so as to reduce the free monomer content, such as to below 1.0 percent and usually below 0.5 percent, based on the total weight of the mixture of polymerizable monomers.

The organic nitrile-based copolymer (e.g., nitrile butadiene rubber (NBR)), can then be hydrogenated to form hydrogenated organic nitrile-based copolymer (e.g., hydrogenated nitrile butadiene rubber (HNBR)). After hydrogenation, residual unsaturation in the hydrogenated organic nitrile-based copolymer (e.g., hydrogenated nitrile butadiene rubber (HNBR)) is from about 0.1% to about 5%, or from about 0.1% to about 4%, or from about 0.1% to about 3%, or from about 0.1% to about 2%, or from about 0.1% to about 1%.

To prepare the phenol-based homopolymer (e.g., poly(4-vinylphenol) (PVPL)), the solvent may be first heated to reflux and the mixture of polymerizable monomer (e.g., 4-vinylphenol) containing the free radical initiator may be added slowly to the refluxing solvent. The reaction mixture is then held at polymerizing temperatures so as to reduce the free monomer content, such as to below 1.0 percent and usually below 0.5 percent, based on the total weight of the polymerizable monomer.

Polymerization using a coupling agent can be used to prepare the phenol-based copolymer (e.g., Novolaks (phenolic resins), p-tert-butyl phenol formaldehyde resin (PTBP-FR), and the like.

The phenol-based copolymer may be prepared by polymerization techniques in which the polymerizable monomers and a coupling agent are dissolved in an organic medium comprising a solvent or a mixture of solvents and polymerized in the presence of acid or base catalyst until conversion is complete. The organic medium used to produce the copolymer may comprise any suitable organic solvent or mixture of solvents, including those discussed herein with respect to the organic medium.

Suitable coupling agents include, for example, aldehyde, sulfur, silane, or combinations thereof. The coupling ratio of the coupling agent to the phenolic compound, can be from about 1.2:1 to about 0.8:1. Preferably, the coupling ratio of the coupling agent to the phenolic compound is 1:1.

### Synergistic Dispersants

The polymer blends of this disclosure are effective as synergistic dispersants.

The synergistic dispersants of this disclosure comprise an organic nitrile-based copolymer/phenol-based polymer blend or an organic nitrile-based copolymer/phenol-based copolymer blend.

In a preferred embodiment, when the synergistic dispersants are present in a conductive carbon dispersion, the conductive carbon dispersion exhibits lower viscosity as compared to a conductive carbon dispersion in which only the organic nitrile-based copolymer, or the phenol-based polymer, or the phenol-based copolymer, is present.

In another preferred embodiment, when the synergistic dispersants are present in an electrode slurry composition, the electrode slurry composition exhibits lower viscosity as compared to an electrode slurry composition in which only the organic nitrile-based copolymer, or the phenol-based polymer, or the phenol-based copolymer, is present.

A synergistic dispersant having a combination or blend of an organic nitrile-based copolymer, and a phenol-based polymer (also referred to as a phenol-based homopolymer) or a phenol-based copolymer of this disclosure, improves the rheological properties of a CNT dispersion, more than use of either polymer or copolymer dispersant alone. This synergistic effect can be used to achieve lower viscosity of the dispersion than industry benchmark polyvinylpyrrolidone (PVP) at constant solid content, or increase solid content of the dispersion at constant viscosity.

A synergistic dispersant having a combination or blend of an organic nitrile-based copolymer, and a phenol-based polymer or a phenol-based copolymer of this disclosure, can be used in LFP cathode slurry compositions to achieve lower viscosity, than using either polymer or copolymer dispersant alone. Lower viscosity can be achieved with the dispersant combination or blend of an organic nitrile-based copolymer, and a phenol-based polymer or a phenol-based copolymer, than viscosity achieved with the industry benchmark PVP dispersant, at high solid content.

PVP is a traditional wetting and dispersing agent for CNT dispersion and cathode slurry formulation. However, PVP is known to be unstable in LiB operation over time, and especially at high voltage, thus causing gassing and thus undesired deformation of the battery.

Hydrogenated nitrile-butadiene rubber (HNBR) is also known as a wetting and dispersing agent for CNT dispersion and viscosity reducer for LFP slurry formulations. However, the cost of HNBR is remarkably high. Replacing part of HNBR with a less expensive secondary dispersant, in accordance with this disclosure, not only reduces cost but also improves performance.

### Dispersant Concentrates

The dispersant concentrates of this disclosure comprise a polymer blend synergistic dispersant of this disclosure, and at least one solvent (e.g., dispersing medium).

The polymer blend synergistic dispersant can be present in the dispersant concentrate in an amount from about 10 to about 80 wt %, or from about 20 to about 60 wt %, or from about 40 to about 60 wt %; and the solvent can be present in an amount from about 20 to about 90 wt %, or from about 40 to about 80 wt %, or from about 40 to about 60 wt %, based on the total weight of the dispersant concentrate.

Illustrative solvents for the dispersant concentrate include, for example, an organic solvent including any one thereof or two or more hetero atoms selected from a nitrogen atom (N) and an oxygen atom (O) having an unshared electron pair.

Specifically, the solvent or dispersion medium may be an amide-based polar organic solvent such as dimethylformamide (DMF), diethylformamide, dimethylacetamide (DMAc) and N-methylpyrrolidone (NMP); an alcohol such as methanol, ethanol, 1-propanol, 2-propanol (isopropyl alcohol), 1-butanol (n-butanol), 2-methyl-1-propanol (isobutanol), 2-butanol (sec-butanol), 1-methyl-2-propanol (tert-butanol), pentanol, hexanol, heptanol and octanol; a glycol such as ethylene glycol, diethylene glycol, triethylene glycol, propylene glycol, 1,3-propanediol, 1,3-butanediol, 1,5-pentanediol, and hexylene glycol; a polyhydric alcohol such as glycerin, trimethylol propane, pentaerythritol, and sorbitol; a glycol ether such as ethylene glycol monomethyl ether, diethylene glycol monomethyl ether, triethylene glycol monomethyl ether, tetraethylene glycol monomethyl ether, ethylene glycol monoethyl ether, diethylene glycol monoethyl ether, triethylene glycol monoethyl ether, tetraethylene glycol monoethyl ether, ethylene glycol monobutyl ether, diethylene glycol monobutyl ether, triethylene glycol monobutyl ether, and tetraethylene glycol monobutyl ether; a ketone such acetone, methyl ethyl ketone, methyl propyl ketone, and cyclopentanone; an ester such as ethyl acetate, γ-butyl lactone, and ε-propiactone. Any one thereof or a mixture of two or more thereof may be used. When considering the miscibility with an electrode slurry, N-methylpyrrolidone (NMP) is particularly preferable among the above.

Preferred solvents for the dispersant concentrate include, for example, N-methyl-2-pyrrolidone, water, toluene, xylene, isopropanol, ethyl acetate, butyl butyrate, and combinations thereof.

Typical dispersant concentrates of this disclosure, with component concentrations, are shown in Table A below.

TABLE A

| | | | More | |
|---|---|---|---|---|
| | | Preferred | preferred | Range |
| Component | Function | wt % | wt % | wt % |
| Synergistic | Dispersing | 20-60% | 40-60% | 10-80% |
| Dispersant | agent | | | |
| NMP | Solvent | 40-80% | 40-60% | 20-90% |

The dispersant concentrates of the present disclosure including the above components may be prepared by mixing the polymer blend synergistic dispersant(s) and solvent(s) or dispersion medium. The mixing may be performed by a typical mixing method, for example, by known means such as a stirrer, bead mill or high-pressure homogenizer, for example, by using a mixing device such as a homogenizer, a beads mill, a ball mill, a basket mill, an attrition mill, an all-purpose stirrer, a clear mixer, a spike mill, a TK mixer, or the like.

As for mixing and agitation for the manufacture of the dispersant concentrates, a mixer capable of stirring these components to such an extent that satisfactory dispersion conditions are met should be selected. Examples of the mixers which meets this condition include ball mill, sand mill, pigment disperser, grinding machine, extruder, rotor stator, pug mill, ultrasonic disperser, homogenizer, planetary mixer, Hobart mixer, and combinations thereof.

### Conductive Carbon Dispersions

The conductive carbon dispersions of this disclosure comprise a polymer blend synergistic dispersant of this disclosure, or at least one dispersant concentrate of this disclosure, at least one conductive carbon, and at least one solvent.

Suitable conductive carbon includes, for example, carbon nanotubes, graphene, carbon black, graphite, and combinations thereof. The conductive carbon material is to improve the conductivity of an electrode.

Illustrative carbon nanotubes useful in this disclosure are described, for example, in WO 2022/040425 A1, the disclosure of which is incorporated herein by reference in its entirety.

In the carbon nanotube, a graphite sheet has a cylindrical shape of a nano-sized diameter and has a sp² bonding structure, and exhibits conductor or semiconductor properties depending on the angle and structure at which the graphite surface is rolled. The carbon nanotube may be classified as a single-walled carbon nanotube (SWCNT), a double-walled carbon nanotube (DWCNT), and a multi-walled carbon nanotube (MWCNT) depending on the number of walls forming the tubes. Such a carbon nanotube may be appropriately selected according to the use of the dispersion.

In addition, the carbon nanotube may have a secondary shape in which a plurality of carbon nanotubes are aggregated or arranged. For example, the carbon nanotube may be a bundle-type carbon nanotube in the form of a bundle or a rope in which or a plurality of carbon nanotubes are arranged or aligned in parallel in a predetermined direction, or may be an entangled-type carbon nanotube in the form of a sphere or a potato in which a plurality of carbon nanotubes are entangled without a certain directionality. In terms of dispersibility, it is more preferable that the carbon nanotube is a bundle-type carbon nanotube.

As the carbon black, commercially available furnace black, channel black, thermal black, acetylene black, ketjen black, hollow carbon black, or the like may be used. The type of the carbon nanotube is not particularly limited.

The carbon black may have been, as needed, surface-treated by a method known in the art. For example, the carbon black may have been surface-treated by acetylene gas, and thus, free of impurities. In addition, the carbon black may have a purity of 99.5% or greater.

The conductive carbon used in the present disclosure may have a BET specific surface area of 1000 m²/g or less, preferably 30 to 1000 m²/g. When the BET specific surface area of the conductive carbon is greater than 1000 m²/g, a dispersion may not be smoothly achieved.

Specifically, when the conductive carbon is a carbon nanotube, the BET specific surface area of the carbon nanotube may be 100 to 1000 m²/g, 150 to 800 m²/g, 150 to 500 m²/g, 150 to 300 m²/g, or 150 to 200 m²/g.

When the conductive carbon is carbon black, the BET specific surface area of the carbon black may be 30 to 1000 m²/g, preferably 30 to 400 m²/g, more preferably 30 to 380 m²/g, even more preferably 30 to 150 m²/g.

In an embodiment, the content of the conductive carbon in the conductive carbon dispersion may be 0.1 to 30 wt %, preferably 1 to 30 wt %. Specifically, when the conductive carbon is a carbon nanotube, the content of the conductive carbon in the conductive carbon dispersion may be 0.1 to 10 wt %, preferably 1 to 8 wt %, and when the conductive carbon is carbon black, the content of the conductive carbon in the conductive carbon dispersion may be 1 to 30 wt %, preferably 1 to 25 wt %. When the content of the conductive carbon is too low, there may be problems in that a loading amount is reduced during the manufacturing of an electrode, so that process cost increases, and binder migration occurs during the manufacturing of the electrode, so that adhesion force is reduced. Meanwhile, when the content of the conductive carbon is too high, there is a problem in that the viscosity of the conductive carbon dispersion increases too high to handle in the process.

In an embodiment, the carbon nanotubes useful in this disclosure have a BET specific surface area of 10 to 2000 m²/g, a Raman spectroscopy 2D/G peak ratio of 0.15 to 1.50, a length of 25 nm to 1 mm, an outer diameter at 0.1 to 100 nm, and an aspect ratio of 100:1 to 100,000,000:1.

The polymer blend synergistic dispersant, or dispersant concentrate, components are described herein.

In the conductive carbon dispersions of this disclosure, the polymer blend synergistic dispersant or dispersant in dispersant concentrate is present in an amount from about 0.1 to about 6 wt %, or from about 0.1 to about 3 wt %, or from about 0.1 to about 1 wt %; the conductive carbon is present in an amount from about 0.5 to about 12 wt %, or from about 0.5 to about 4 wt %, or from about 0.5 to about 1 wt %; and the solvent is present in an amount from about 82 to about 99.5 wt %, or from about 82 to about 98 wt %, or from about 82 to about 95 wt %; based on the total weight of the conductive carbon dispersion.

The weight ratio of carbon nanotubes to polymer blend synergistic dispersant in the conductive carbon dispersion of this disclosure may be 250:1 to 1:1, such as 100:1 to 2:1, such as 75:1 to 3:1, such as 50:1 to 5:1, such as 25:1 to 1:1, such as 25:1 to 2:1, such as 25:1 to 3:1, such as 25:1 to 4.1, such as 25:1 to 5:1, such as 25:1 to 7.5:1, such as 25:1 to 10:1, such as 25:1 to 15:1, such as 20:1 to 1:1, such as 20:1 to 2:1, such as 20:1 to 3:1, such as 20:1 to 4.1, such as 20:1 to 5:1, such as 20:1 to 7.5:1, such as 20:1 to 10:1, such as 20:1 to 15:1, such as 10:1 to 1:1, such as 10:1 to 2:1, such as 10:1 to 3:1, such as 10:1 to 4.1, such as 10:1 to 5:1, such as 10:1 to 7.5:1.

When more than one conductive carbon is present in the conductive carbon dispersion of this disclosure, the weight ratio of the conductive carbon other than carbon nanotubes to carbon nanotubes may be at least 1,000:1, such as at least 750:1, such as at least 400:1, such as at least 300:1, such as at least 200:1, such as at least 150:1, such as at least 125:1, such as at least 100:1, such as at least 75:1, such as at least 50:1, such as at least 25:1, such as at least 20:1, such as at least 15:1, such as at least 13:1, such as at least 10:1, such as at least 5:1. The weight ratio of the conductive carbon other than carbon nanotubes to carbon nanotubes may be no more than 5:1, such as no more than 10:1, such as no more than 15:1, such as no more than 20:1, such as no more than 25:1, such as no more than 50:1, such as no more than 75:1, such as no more than 100:1, such as no more than 125:1, such as no more than 150:1, such as no more than 200:1, such as no more than 300:1, such as no more than 400:1, such as no more than 75:1.

Illustrative solvents for the conductive carbon dispersions of this disclosure include, for example, an organic solvent including any one thereof or two or more hetero atoms selected from a nitrogen atom (N) and an oxygen atom (O) having an unshared electron pair.

Specifically, the solvent or dispersion medium may be an amide-based polar organic solvent such as dimethylformamide (DMF), diethylformamide, dimethylacetamide (DMAc) and N-methylpyrrolidone (NMP); an alcohol such as methanol, ethanol, 1-propanol, 2-propanol (isopropyl alcohol), 1-butanol (n-butanol), 2-methyl-1-propanol (isobutanol), 2-butanol (sec-butanol), 1-methyl-2-propanol (tert-butanol), pentanol, hexanol, heptanol and octanol; a glycol such as ethylene glycol, diethylene glycol, triethylene glycol, propylene glycol, 1,3-propanediol, 1,3-butanediol, 1,5-pentanediol, and hexylene glycol; a polyhydric alcohol such as glycerin, trimethylol propane, pentaerythritol, and sorbitol; a glycol ether such as ethylene glycol monomethyl ether, diethylene glycol monomethyl ether, triethylene glycol monomethyl ether, tetraethylene glycol monomethyl ether, ethylene glycol monoethyl ether, diethylene glycol monoethyl ether, triethylene glycol monoethyl ether, tetraethylene glycol monoethyl ether, ethylene glycol monobutyl ether, diethylene glycol monobutyl ether, triethylene glycol monobutyl ether, and tetraethylene glycol monobutyl ether; a ketone such acetone, methyl ethyl ketone, methyl propyl ketone, and cyclopentanone; an ester such as ethyl acetate, γ-butyl lactone, and ε-propiactone. Any one thereof or a mixture of two or more thereof may be used. When considering the miscibility with an electrode slurry, N-methylpyrrolidone (NMP) is particularly preferable among the above.

Preferred solvents for the conductive carbon dispersions of this disclosure include, for example, N-methyl-2-pyrrolidone, water, toluene, xylene, isopropanol, ethyl acetate, butyl butyrate, and combinations thereof.

Typical conductive carbon dispersions of this disclosure, with component concentrations, are shown in Table B below.

TABLE B

| | | More | | |
|---|---|---|---|---|
| | | Preferred | Preferred | Range |
| Component | Function | wt % | wt % | wt % |
| Conductive | Conductive | 1% | 4% | 0.5-12% |
| carbon | agent | | | |
| Synergistic | Dispersing | 1% | 1% | 0.1-6% |
| Dispersant | agent | | | |
| NMP | Solvent | 98% | 95% | 82-99.4% |

The conductive carbon dispersions of this disclosure including the above components may be prepared by mixing the polymer blend synergistic dispersant(s) or dispersant concentrate(s), conductive carbon material(s), and solvent(s) or dispersion medium. The mixing may be performed by a typical mixing method, for example, by known means such as a stirrer, bead mill or high-pressure homogenizer, for example, by using a mixing device such as a homogenizer, a beads mill, a ball mill, a basket mill, an attrition mill, an all-purpose stirrer, a clear mixer, a spike mill, a TK mixer, or the like. The mixing order of each component is not particularly limited. That is, the conductive carbon dispersion of the present disclosure may be prepared by adding a conductive carbon material to a dispersion medium, and then adding a dispersant thereto, followed by mixing; or prepared by first adding a polymer blend synergistic dispersant to a dispersion medium, and then mixing a conductive carbon material therewith; or prepared by adding both a polymer blend synergistic dispersant and a conductive carbon material to a dispersion medium, followed by mixing.

As for mixing and agitation for the manufacture of the conductive carbon dispersion, a mixer capable of stirring these components to such an extent that satisfactory dispersion conditions are met should be selected. The degree of dispersion can be measured with a particle gauge and mixing and dispersion are preferably carried out to ensure that agglomerates of 100 microns or more are not present. Examples of the mixers which meets this condition include ball mill, sand mill, pigment disperser, grinding machine, extruder, rotor stator, pug mill, ultrasonic disperser, homogenizer, planetary mixer, Hobart mixer, and combinations thereof.

The solid content of the conductive carbon dispersions of this disclosure is determined according to the solid amount of the polymer blend synergistic dispersant or dispersant concentrate, and conductive carbon material. In accordance with this disclosure, the conductive carbon dispersions have a high solid content, while surprisingly exhibiting low viscosity properties.

In an embodiment, the conductive carbon dispersions of this disclosure exhibit high solid content and low viscosity properties. For example, the conductive carbon dispersions of this disclosure have a viscosity (Pa·s) from about 1 to about 80 Pa·s, and a solids content (wt %) from about 50 to about 80 wt %, at a shear rate (1/s) from about 0.1 to about 100 1/s; or a viscosity (Pa·s) from about 5 to about 75 Pa·s, and a solids content (wt %) from about 50 to about 75 wt %, at a shear rate (1/s) from about 0.1 to about 100 1/s; or a viscosity (Pa·s) from about 5 to about 50 Pa·s, and a solids content (wt %) from about 50 to about 70 wt %, at a shear rate (1/s) from about 0.1 to about 100 1/s; or a viscosity (Pa·s) from about 5 to about 25 Pa·s, and a solids content (wt %) from about 55 to about 70 wt %, at a shear rate (1/s) from about 0.1 to about 100 1/s.

### Electrode Slurry Compositions

In accordance with this disclosure, the electrode slurry composition for producing a battery positive electrode comprise the conductive carbon dispersion of this disclosure, at least one electrode active material, at least one binder, and optionally at least one solvent.

The conductive carbon dispersions of this disclosure are described herein.

In the electrode slurry compositions of this disclosure, the conductive carbon dispersion is present in an amount from about 0.1 to about 10 wt %, 0.1 to about 8 wt %, 0.1 to about 6 wt %, or from about 0.1 to about 3 wt %, or from about 0.1 to about 1 wt %; based on the total weight of the electrode slurry composition.

The electrode active material may comprise a material for use as an active material for a positive electrode. The electrochemically electrode active material may comprise a material capable of incorporating lithium (including incorporation through lithium intercalation/deintercalation), a material capable of lithium conversion, or combinations thereof. Non-limiting examples of electrode active materials capable of incorporating lithium include LiCoO₂, LiNiO₂, LiFePO₄, LiMnₓFe₍₁₋ₓ₎PO₄, LiCoPO₄, LiMnO₂, LiM₂O₄, Li(NiMnCo)O₂, Li(NiCoAl)O₂, carbon-coated LiFePO₄, and combinations thereof. Non-limiting examples of materials capable of lithium conversion include sulfur, LiO₂, FeF₂ and FeF₃, aluminum, tin, SnCo, Fe₃O₄, and combinations thereof.

Illustrative electrode active materials include, for example, lithium iron phosphate (LiFePO₄), lithium manganese iron phosphate (LiMnₓFe₍₁₋ₓ₎PO₄), lithium cobalt oxide (LiCoO₂), lithium manganese oxide (LiMn₂O₄), lithium manganese oxide (Li₂MnO₃), lithium nickel manganese cobalt oxide (LiNi_{0.33}Mn_{0.33}Co_{0.33}O₂), lithium nickel manganese cobalt oxide (LiNi_{0.6}Mn_{0.2}Co_{0.2}O₂), and lithium nickel manganese cobalt oxide (LiNi_{0.8}Mn_{0.1}Co_{0.1}O₂).

Other illustrative electrode active materials include, for example, a lithium oxide containing one or more metals selected from the group consisting of cobalt, manganese, nickel, and aluminum; a lithium oxide selected from the group consisting of a lithium-manganese-based oxide, LiMnO₂, and LiMn₂O; a lithium-cobalt-based oxide, and LiCoO₂; a lithium-nickel-based oxide and LiNiO₂; a lithium-nickel-manganese-based oxide, LiNi_{1-Y1}Mn_{Y1}O₂ wherein 0<Y1<1, LiNi_{Z1}Mn_{2-Z1}O₄ wherein 0<Z1<2; a lithium-nickel-cobalt-based oxide, LiNi_{1-Y2}Co_{Y2}O₂ wherein 0<Y2<1; a lithium-manganese-cobalt-based oxide, LiCo_{1-Y3}Mn_{Y3}O₂ wherein 0<Y3<1, LiMn_{2-Z2}Co_{Z2}O₄ wherein 0<Z2<2; a lithium-nickel-cobalt-manganese-based oxide, Li(Ni_{P1}Co_{Q1}Mn_{R1})O₂ wherein 0<P1<1, 0<Q1<1, 0<R1<1, P1+Q1+R1=1, Li(Ni_{P2}Co_{Q2}Mn_{R2})O₄ wherein 0<P2<2, 0<Q2<2, 0<R2<2, P2+Q2+R2=2; and a lithium-nickel-cobalt-manganese-other metal (M) oxide, Li(Ni_{P3}Co_{Q3}Mn_{R3}M¹ s)O₂ wherein M¹ is selected from the group consisting of Al, Cu, Fe, V, Cr, Ti, Zr, Zn, Ta, Nb, Mg, B, W and Mo, and P3, Q3, R3, and S are each an atomic fraction of independent elements, and 0<P3<1, 0<Q3<1, 0<R3<1, 0<S<1, P3+Q3+R3+S=1; and combinations thereof.

The electrode active material may be present in the electrode slurry composition of this disclosure in amounts of 45% to 99% by weight, such as 50% to 95% by weight, such as 55% to 90% by weight, such as 60% to 85% by weight, such as 65% to 80% by weight, based on the total solids weight of the electrode slurry composition.

Illustrative binders include, for example, polyvinylidene fluoride (PVDF), a vinylidene fluoride-hexafluoropropylene copolymer (PVDF-co-HFP), polyvinyl alcohol, polyacrylonitrile, carboxymethyl cellulose (CMC), starch, hydroxypropyl cellulose, regenerated cellulose, polyvinylpyrrolidone, polytetrafluoroethylene, polyethylene, polypropylene, an ethylene-propylene-diene monomer (EPDM), a sulfonated-EPDM, styrene-butadiene rubber (SBR), fluorine rubber, or copolymers thereof, and combinations thereof.

The binder may be included in the electrode slurry compositions of this disclosure in an amount of about 5 wt % or less, or about 4 wt % or less, or about 3 wt % or less, or about 2 wt % or less, or about 1 wt % or less, based on the total solid content in the electrode slurry composition, and may preferably be included in an amount from about 1 to about 3 wt %. When the content of binder satisfies the above range, it is possible to implement excellent electrode adhesion force while minimizing the increase in electrode resistance.

In an embodiment, the electrode active material is lithium iron phosphate (LFP) and is present in an amount of about 100 parts by weight; the conductive carbon is present in an amount from about 0.2 to about 10 parts by weight, or from about 0.5 to about 2 parts by weight, or from about 0.5 to about 1.5 parts by weight; the dispersant is present in an amount from about 0.02 to about 0.5 parts by weight, or from about 0.05 to about 0.02 parts by weight, or from about 0.1 to about 0.2 parts by weight; the binder is present in an amount from about 0.5 to about 5 parts by weight, or from about 1.5 to about 2 parts by weight, or from about 0.5 to about 2 parts by weight; and the solvent is present in an amount from about 50 to about 75 parts by weight, or from about 55 to about 70 parts by weight, or from about 60 to about 65 parts by weight.

In an embodiment, the electrode active material is lithium nickel manganese cobalt oxide (NMC) and is present in an amount of about 100 parts by weight, or from about 97 to 99 parts by weight, or from about 97 to about 98.3 parts by weight; the conductive carbon is carbon nanotubes and is present in an amount from about 0.2 to about 10 parts by weight, or from about 0.5 to about 2 parts by weight, or from about 0.5 to about 1.5 parts by weight; the dispersant is present in an amount from about 0.02 to about 0.5 parts by weight, or from about 0.1 to about 1 parts by weight, or from about 0.1 to about 0.25 parts by weight; the binder is present in an amount from about 0.5 to about 5 parts by weight, or from about 0.5 to about 1.5 parts by weight, or from about 0.5 to about 0.7 parts by weight; and the solvent is present in an amount from about 50 to about 75 parts by weight, or from about 55 to about 70 parts by weight, or from about 60 to about 65 parts by weight.

The electrode slurry composition of this disclosure may further include a solvent, if necessary, to control viscosity and the like. The solvent may be water, an organic solvent, or a mixture thereof. The organic solvent may be, for example, an amide-based polar organic solvent such as dimethylformamide (DMF), diethylformamide, dimethylacetamide (DMAc), and N-methylpyrrolidone (NMP); an alcohol such as methanol, ethanol, 1-propanol, 2-propanol (isopropyl alcohol), 1-butanol (n-butanol), 2-methyl-1-propanol (isobutanol), 2-butanol (sec-butanol), 1-methyl-2-propanol (tert-butanol), pentanol, hexanol, heptanol, and octanol; a glycol such as ethylene glycol, diethylene glycol, triethylene glycol, propylene glycol, 1,3-propanediol, 1,3-butanediol, 1,5-pentanediol, and hexylene glycol; a polyhydric alcohol such as glycerin, trimethylol propane, pentaerythritol, and sorbitol; a glycol ether such as ethylene glycol monomethyl ether, diethylene glycol monomethyl ether, triethylene glycol monomethyl ether, tetraethylene glycol monomethyl ether, ethylene glycol monoethyl ether, diethylene glycol monoethyl ether, triethylene glycol monoethyl ether, tetraethylene glycol monoethyl ether, ethylene glycol monobutyl ether, diethylene glycol monobutyl ether, triethylene glycol monobutyl ether, and tetraethylene glycol monobutyl ether; a ketone such acetone, methyl ethyl ketone, methyl propyl ketone, and cyclopentanone; and an ester such as ethyl acetate, γ-butyl lactone, and ε-propiactone. Any one thereof and a mixture of two or more thereof may be used, but the organic solvent is not limited thereto.

The solvent may be included in a content such that the solid content in the electrode slurry composition becomes 60 to 85 wt %, preferably 65 to 80 wt %. When the solid content of the electrode slurry composition is less than 60 wt %, an electrode loading amount may be reduced, thereby increasing process cost, binder migration may occur, thereby degrading electrode adhesion force, and coating defects may be generated. When the solid content of the electrode slurry composition is greater than 85 wt %, the viscosity of the electrode slurry composition becomes too high, so that processability may be deteriorated and coating defects may be generated.

Typical electrode slurry compositions of this disclosure, with component concentrations, are shown in Tables C (LFP electrode slurry composition) and D (NMC electrode slurry composition) below.

TABLE C

| | | More | | |
|---|---|---|---|---|
| | | preferred | Preferred | Range |
| Component | Function | (part) | (part) | (part) |
| Lithium iron | Active | 100 | 100 | 100 |
| phosphate | materials | | | |
| (LFP) | | | | |
| Conductive | Conductive | 1.5 | 0.5-2.0 | 0.2-10 |
| carbon | agent | | | |
| Synergistic | Dispersing | 0.2 | 0.1-0.2 | 0.02-0.5 |
| Dispersant | agent | | | |
| PVDF | Binder | 2.0 | 1.5-2.0 | 0.5-5.0 |
| Total above | Solid content | 103.7 | 102.1-104.2 | 100.72-115.5 |
| (non- | (SC) | | | |
| volatile) | | | | |
| NMP | Solvent | Balanced | Balanced | Balanced |
| | | to 65% | to 60-70% | to 50-75% |
| | | SC | SC | SC |

TABLE D

| | | More | | |
|---|---|---|---|---|
| | | Preferred | Preferred | Range |
| Component | Function | (part) | (part) | (part) |
| Lithium Nickel | Active | 98.3 | 97.0-99.0 | 100 |
| Manganese | materials | | | |
| Cobalt | | | | |
| oxide (NMC) | | | | |
| Carbon | Conductive | 1.0 | 0.5-2.0 | 0.2-10.0 |
| Nanotubes | agent | | | |
| (CNT) | | | | |
| Synergistic | Dispersing | 0.25 | 0.1-1.0 | 0.02-5.0 |
| Dispersant | agent | | | |
| (included in | | | | |
| CNT | | | | |
| dispersion) | | | | |
| PVDF | Binder | 0.7 | 0.5-1.5 | 0.5-5.0 |
| Total above | Solid content | 100.25 | 98.1-103.5 | 100.72-120.0 |
| (non-volatile) | (SC) | | | |
| NMP | Solvent | Balanced | Balanced | Balanced |
| | | to situable | to situable | to situable |
| | | viscosity | viscosity | viscosity |

The electrode slurry compositions of this disclosure including the above components may be prepared by mixing or agitating the conductive carbon dispersion of this disclosure, the electrode active material, the binder, and optionally the solvent. The mixing may be performed by a typical mixing method, for example, by known means such as a stirrer, bead mill or high-pressure homogenizer, for example, by using a mixing device such as a homogenizer, a beads mill, a ball mill, a basket mill, an attrition mill, an all-purpose stirrer, a clear mixer, a spike mill, a TK mixer, or the like. The mixing order of each component is not particularly limited. That is, the electrode slurry compositions of the present disclosure may be prepared by adding a conductive carbon dispersion of this disclosure to a dispersion medium, then adding an electrode active material thereto, and then adding a binder thereto, followed by mixing; or prepared by first adding an electrode active material to a dispersion medium, and then mixing binder and a conductive carbon dispersion of this disclosure therewith; or prepared by adding a conductive carbon dispersion of this disclosure thereto, an electrode active material, and a binder, all together to a dispersion medium, followed by mixing.

As for mixing and agitation for the manufacture of the electrode slurry composition, a mixer capable of stirring these components to such an extent that satisfactory dispersion conditions are met should be selected. The degree of dispersion can be measured with a particle gauge and mixing and dispersion are preferably carried out to ensure that agglomerates of 100 microns or more are not present. Examples of the mixers which meets this condition include ball mill, sand mill, pigment disperser, grinding machine, extruder, rotor stator, pug mill, ultrasonic disperser, homogenizer, planetary mixer, Hobart mixer, and combinations thereof.

The solid content of the positive electrode slurry composition of this disclosure is determined according to the solid amount of the conductive carbon dispersion, the electrode active material, and the binder. When the solid content of a positive electrode slurry composition is high, there are effects such as the increase in productivity, improvement in electrode drying efficiency and binder migration, improvement in adhesion force, and the like. In accordance with this disclosure, the electrode slurry compositions have a high solid content, while surprisingly exhibiting low viscosity properties.

In an embodiment, the electrode slurry compositions of this disclosure exhibit high solid content and low viscosity properties. For example, the electrode slurry compositions of this disclosure have a viscosity (Pa·s) from about 5 to about 30 Pa·s, and a solids content (wt %) from about 50 to about 80 wt %, at a shear rate (1/s) from about 0.1 to about 100 1/s; or a viscosity (Pa·s) from about 5 to about 25 Paos, and a solids content (wt %) from about 50 to about 75 wt %, at a shear rate (1/s) from about 0.1 to about 100 1/s; or a viscosity (Pa·s) from about 5 to about 20 Pa·s, and a solids content (wt %) from about 50 to about 70 wt %, at a shear rate (1/s) from about 0.1 to about 100 1/s; or a viscosity (Pa·s) from about 5 to about 15 Pa·s, and a solids content (wt %) from about 55 to about 70 wt %, at a shear rate (1/s) from about 0.1 to about 100 1/s.

### Positive Electrodes

The positive electrodes of this disclosure comprise an electrical current collector and a film formed on the electrical current collector, wherein the film is deposited from the electrode slurry composition of this disclosure, and the solvent subsequently removed.

The electrode according to the present disclosure may be manufactured by forming an electrode active material layer by applying an electrode slurry composition including the above components, followed by drying. Specifically, the electrode active material layer may be formed by a method in which an electrode slurry composition is applied on an electrode current collector and then dried, or by a method in which an electrode slurry is applied on a separate support, and then laminating a film obtained by being peeled off from the support on an electrode current collector. If necessary, after forming an electrode active material layer through the above method, a process of roll-pressing the same may be additionally performed. At this time, drying and roll-pressing may be performed under appropriate conditions in consideration of the physical properties of an electrode to be finally manufactured, and are not particularly limited.

The electrode active material layer may have a thickness of at least 1 micron, such as 1 to 500 microns (μm), such as 1 to 150 μm, such as 25 to 150 μm, such as 30 to 125 μm. The current collector may comprise a conductive material, and the conductive material may comprise a metal such as iron, copper, aluminum, nickel, and alloys thereof, as well as stainless steel. For example, the current collector may comprise aluminum or copper in the form of a mesh, sheet, or foil.

Although the shape and thickness of the current collector are not particularly limited, the current collector may have a thickness of about 0.001 to 0.5 mm, such as a mesh, sheet or foil having a thickness of about 0.001 to 0.5 mm.

In addition, the current collector may be pretreated with a pretreatment composition prior to depositing the slurry composition. As used herein, a pretreatment composition refers to a composition that upon contact with the current collector, reacts with and chemically alters the current collector surface and binds to it to form a protective layer. The pretreatment composition may be a pretreatment composition comprising a group IIIB and/or IVB metal.

The method of applying the electrode slurry composition to the current collector is not particularly limited. The electrode slurry composition may be applied by doctor blade coating, dip coating, reverse roll coating, direct roll coating, gravure coating, extrusion coating, immersion or brushing. Although the application quantity of the electrode slurry composition is not particularly limited, the thickness of the coating formed after the organic medium is removed may be 25 to 150 microns (μm), such as 30 to 125 μm.

Drying the coating film after application, if applicable, can be done, for example, by heating at elevated temperature, such as at least 50° C., such as at least 60° C., such as 50-145° C., such as 60-120° C., such as 65-110° C. The time of heating will depend somewhat on the temperature. Generally, higher temperatures require less time for drying. Typically, drying times are for at least 5 minutes, such as 5 to 60 minutes.

### Electrical Storage Devices

Electrical storage devices of this disclosure comprise the positive electrode of this disclosure, a negative electrode, a separator, and an electrolyte. Preferably, the electrical storage device is a cell, a battery, a battery pack, a secondary battery, or a capacitor.

In an embodiment, a secondary battery includes the positive electrode of the present disclosure. Specifically, the secondary battery according to the present disclosure may include a positive electrode of this disclosure, a negative electrode, a separator interposed between the positive electrode and the negative electrode, and an electrolyte.

The positive electrode according to the present disclosure has been described herein.

The separator is to separate the negative electrode and the positive electrode and to provide a movement path for lithium ions. Any separator may be used without particular limitation as long as it is a separator typically used in a lithium secondary battery. Specifically, as the separator, a porous polymer film, for example, a porous polymer film manufactured using a polyolefin-based polymer such as an ethylene homopolymer, a propylene homopolymer, an ethylene/butene copolymer, an ethylene/hexene copolymer, and an ethylene/methacrylate copolymer, or a laminated structure having two or more layers thereof may be used. Also, a typical porous non-woven fabric, for example, a non-woven fabric formed of glass fiber having a high melting point, polyethylene terephthalate fiber, or the like may be used. Also, a coated separator including a ceramic component or a polymer material may be used to secure heat resistance or mechanical strength, and may be selectively used in a single-layered or a multi-layered structure.

The electrolyte may be an organic liquid electrolyte, an inorganic liquid electrolyte, a solid polymer electrolyte, a gel-type polymer electrolyte, a solid inorganic electrolyte, a molten-type inorganic electrolyte, and the like, which may be used in the preparation of a lithium secondary battery, but is not limited thereto.

Specifically, the electrolyte may include a non-aqueous organic solvent and a lithium salt.

As the non-aqueous organic solvent, for example, an aprotic organic solvent, such as N-methyl-2-pyrrolidone, propylene carbonate, ethylene carbonate, butylene carbonate, dimethyl carbonate, diethyl carbonate, γ-butyrolactone, 1,2-dimethoxy ethane, tetrahydroxyfuran, 2-methyl tetrahydrofuran, dimethyl sulfoxide, 1,3-dioxolane, formamide, diemthylformamide, dioxolane, acetonitrile, nitromethane, methyl formate, methyl acetate, phosphate triester, trimethoxy methane, a dioxolane derivative, sulfolane, methyl sulfolane, 1,3-dimethyl-2-imidazolidinone, a propylene carbonate derivative, a tetrahydrofuran derivative, ether, methyl propionate, and ethyl propionate may be used.

In particular, among the carbonate-based organic solvents, a cyclic carbonate such as ethylene carbonate and propylene carbonate may preferably be used since it is an organic solvent of high viscosity and has high dielectric constant to dissociate a lithium salt well. Such a cyclic carbonate may be more preferably used since when it is mixed with a linear carbonate of low viscosity and low dielectric constant such as dimethyl carbonate and diethyl carbonate in an appropriate ratio, an electrolyte having a high electric conductivity is prepared.

As the metal salt, a lithium salt may be used. The lithium salt is a material which is easily dissolved in the non-aqueous electrolyte solution. For example, as an anion of the lithium salt, one or more selected from the group consisting of F⁻, Cl⁻, I⁻, NO₃⁻, N(CN)₂⁻, BF₄⁻, ClO₄⁻, PF₆⁻, (CF₃)₂PF₄⁻, (CF₃)₃PF₃⁻, (CF₃)₄PF₂⁻, (CF₃)₅PF⁻, (CF₃)₆P⁻, CF₃SO₃⁻, CF₃CF₂SO₃⁻, (CF₃SO₂)₂N⁻, (FSO₂)₂N⁻, CF₃CF₂ (CF₃)₂Co⁻, (CF₃SO₂)₂CH⁻, (SF₅)₃C⁻, (CF₃SO₂)₃C⁻, CF₃(CF₂)₇SO₃⁻, CF₃Co₂⁻, CH₃Co₂⁻, SCN⁻, and (CF₃CF₂SO₂)₂N⁻ may be used.

In the electrolyte, in order to improve the lifespan properties of a battery, to suppress the decrease in battery capacity, and to improve the discharge capacity of the battery, one or more additives, for example, a halo-alkylene carbonate-based compound such as difluoroethylene carbonate, pyridine, triethylphosphite, triethanolamine, cyclic ether, ethylenediamine, n-glyme, hexaphosphoric triamide, a nitrobenzene derivative, sulfur, a quinone imine dye, N-substituted oxazolidinone, N,N-substituted imidazolidine, ethylene glycol dialkyl ether, an ammonium salt, pyrrole, 2-methoxy ethanol, or aluminum trichloride, and the like may be further included other than the above electrolyte components.

As used herein, the term “polymer” refers broadly to oligomers and homopolymers, copolymers, and polymers. The term “resin” is used interchangeably with “polymer”.

As used herein, the term “solids” refers to the non-volatile components of the conductive carbon dispersion or electrode slurry composition of the present disclosure and specifically excludes the organic medium.

As used herein, molecular weights were determined by gel permeation chromatography (GPC) using a polystyrene standard. The term “number average molecular weight (Mn)”, as used herein, refers to the absolute number average molecular weight (Mn) as measured by GPC. The term “weight average molecular weight (Mw)”, as used herein, refers to a conversion value for a standard polystyrene measured by GPC.

Additionally or alternatively, the present disclosure may include one or more of the following embodiments.

Embodiment 1. A polymer blend comprising:
an organic nitrile-based copolymer; and
a phenol-based polymer or a phenol-based copolymer;
wherein the organic nitrile-based copolymer comprises structural units comprising the residue of a substituted or unsubstituted, unsaturated organic nitrile monomer; and structural units comprising the residue of a substituted or unsubstituted, conjugated diene monomer;
wherein the phenol-based polymer comprises structural units comprising the residue of a substituted or unsubstituted, unsaturated phenolic monomer;
wherein the phenol-based copolymer comprises structural units comprising the residue of a substituted or unsubstituted, unsaturated coupled phenolic resin; and
wherein the organic nitrile-based copolymer is present in an amount from about 0.5 wt % to about 99.5 wt %, and the phenol-based polymer, or the phenol-based copolymer, is present in an amount from about 0.5 wt % to about 99.5 wt %, based on the total weight of the polymer blend.

Embodiment 2. The polymer blend of embodiment 1 wherein the organic nitrile-based copolymer is in the form of a block copolymer, a random copolymer, or a gradient copolymer.

Embodiment 3. The polymer blend of embodiment 1 which comprises an organic nitrile-based copolymer/phenol-based polymer blend or an organic nitrile-based copolymer/phenol-based copolymer blend.

Embodiment 4. The polymer blend of embodiment 1 wherein the organic nitrile-based copolymer is present in an amount from about 1 wt % to about 99 wt %, or from about 1 wt % to about 90 wt %, or from about 1 wt % to about 80 wt %, or from about 1 wt % to about 70 wt %, or from about 1 wt % to about 60 wt %, or from about 1 wt % to about 50 wt %, or from about 1 wt % to about 40 wt %, or from about 1 wt % to about 30 wt %, or from about 1 wt % to about 20 wt %, or from about 1 wt % to about 10 wt %, based on the total weight of the polymer blend.

Embodiment 5. The polymer blend of embodiment 1 wherein the phenol-based polymer, or phenol-based copolymer, is present in an amount from about 1 wt % to about 99 wt %, or from about 1 wt % to about 90 wt %, or from about 1 wt % to about 80 wt %, or from about 1 wt % to about 70 wt %, or from about 1 wt % to about 60 wt %, or from about 1 wt % to about 50 wt %, or from about 1 wt % to about 40 wt %, or from about 1 wt % to about 30 wt %, or from about 1 wt % to about 20 wt %, or from about 1 wt % to about 10 wt %, based on the total weight of the polymer blend.

Embodiment 6. The polymer blend of embodiment 1 wherein the weight ratio of the organic nitrile-based copolymer to the phenol-based polymer, or phenol-based copolymer, in the polymer blend is from about 1:99 to about 99:1, or from about 1:99 to about 90:10, or from about 1:99 to about 80:20, or from about 1:99 to about 70:30, or from about 1:99 to about 60:40, or from about 1:99 to about 50:50, or from about 1:99 to about 40:60, or from about 1:99 to about 30:70, or from about 1:99 to about 20:80, or from about 1:99 to about 10:90.

Embodiment 7. The polymer blend of embodiment 1 wherein the substituted or unsubstituted, unsaturated organic nitrile monomer is substituted or unsubstituted acrylonitrile monomer.

Embodiment 8. The polymer blend of embodiment 1 wherein the substituted or unsubstituted, unsaturated organic nitrile monomer is represented by the formula:

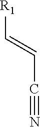

or by formula:

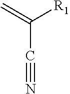

wherein R₁ is hydrogen or an alkyl group having from 1 to 10 carbon atoms.

Embodiment 9. The polymer blend of embodiment 7 wherein R₁ is hydrogen.

Embodiment 10. The polymer blend of embodiment 1 wherein the substituted or unsubstituted, conjugated diene monomer is substituted or unsubstituted butadiene monomer.

Embodiment 11. The polymer blend of embodiment 1 wherein the organic nitrile-based copolymer comprises structural units of the residue of acrylonitrile and structural units of the residue of butadiene, and is represented by the formula:

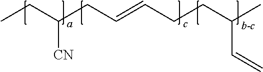

wherein a is a value from 100 to 800, b is a value from 200 to 1200, and c is a value from 0 to 1200; and
wherein the structural units of the residue of acrylonitrile are present in an amount from about 10 wt % to about 60 wt %, based on the total weight of the organic nitrile-based copolymer.

Embodiment 12. The polymer blend of embodiment 1 wherein the phenol-based polymer is a phenolic homopolymer represented by the formula:

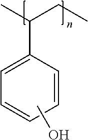

wherein n is a value from about 5 to about 2000.

Embodiment 13. The polymer blend of embodiment 1 wherein the phenol-based copolymer is a coupled phenolic resin represented by the formula:

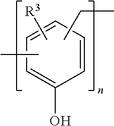

wherein R₃ is hydrogen or an alkyl group having from 1 to 20 carbon atoms, and n is a value from 5 to 2000.

Embodiment 14. The polymer blend of embodiment 1 wherein the coupled phenolic resin comprises a substituted or unsubstituted phenolic compound coupled with a coupling agent.

Embodiment 15. The polymer blend of embodiment 14 wherein the phenolic compound is selected from the group consisting of phenol, p-cresol, p-tert-butyl phenol, salicyl alcohol, and p-nonyl phenol.

Embodiment 16. The polymer blend of embodiment 14 wherein the coupling agent is selected from the group consisting of a substituted or unsubstituted aldehyde, sulfur, silane, and combinations thereof.

Embodiment 17. The polymer blend of embodiment 15 wherein the substituted or unsubstituted aldehyde is represented by the formula

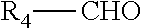

wherein R₄ is hydrogen or an alkyl group having from 1 to about 10 carbon atoms.

Embodiment 18. The polymer blend of embodiment 16 wherein the coupling agent is formaldehyde.

Embodiment 19. The polymer blend of embodiment 1 wherein the molar coupling ratio of the coupling agent to the phenolic compound, is from about 1.2:1 to about 0.8:1.

Embodiment 20. The polymer blend of embodiment 14 wherein the coupling ratio of the coupling agent to the phenolic compound is 1:1.

Embodiment 21. The polymer blend of embodiment 1 wherein the structural units comprising the residue of a substituted or unsubstituted, unsaturated organic nitrile monomer are present in an amount from about 1 wt % to about 99 wt %, or from about 1 wt % to about 90 wt %, or from about 1 wt % to about 80 wt %, or from about 1 wt % to about 70 wt %, or from about 1 wt % to about 60 wt %, or from about 1 wt % to about 50 wt %, or from about 1 wt % to about 40 wt %, or from about 1 wt % to about 30 wt %, or from about 1 wt % to about 20 wt %, or from about 1 wt % to about 10 wt %, based on the total weight of the organic nitrile-based copolymer.

Embodiment 22. The polymer blend of embodiment 1 wherein the structural units comprising the residue of a substituted or unsubstituted, unsaturated organic nitrile monomer are present in an amount from about 25 wt % to about 50 wt %, or from about 30 wt % to about 45 wt %, or from about 30 wt % to about 40 wt %, based on the total weight of the organic nitrile-based copolymer.

Embodiment 23. The polymer blend of embodiment 1 wherein the structural units comprising the residue of a substituted or unsubstituted, conjugated diene monomer are present in an amount from about 1 wt % to about 99 wt %, or from about 10 wt % to about 95 wt %, or from about 20 wt % to about 90 wt %, or from about 30 wt % to about 85 wt %, or from about 40 wt % to about 80 wt %, or from about 50 wt % to about 80 wt %, or from about 55 wt % to about 75 wt %, or from about 60 wt % to about 70 wt %, based on the total weight of the organic nitrile-based copolymer.

Embodiment 24. The polymer blend of embodiment 1 wherein the weight ratio of the structural units comprising the residue of a substituted or unsubstituted, unsaturated organic nitrile monomer to the structural units comprising the residue of a substituted or unsubstituted, conjugated diene monomer in the organic nitrile-based copolymer is from about 1:99 to about 99:1, or from about 1:99 to about 90:10, or from about 1:99 to about 80:20, or from about 1:99 to about 70:30, or from about 1:99 to about 60:40, or from about 1:99 to about 50:50, or from about 1:99 to about 40:60, or from about 1:99 to about 30:70, or from about 1:99 to about 20:80, or from about 1:99 to about 10:90.

Embodiment 25. The polymer blend of embodiment 1 wherein the organic nitrile-based copolymer has a density between about 0.5-2.0 g/cm³, or between about 0.5-1.5 g/cm³, or between about 0.5-1.25 g/cm³, or between about 0.75-1.0 g/cm³.

Embodiment 26. The polymer blend of embodiment 1 wherein the organic nitrile-based copolymer has a Mooney viscosity (ML(1+4) at 100° C.) from about 30 to about 150, or from about 30 to about 100, or from about 30 to about 90, or from about 30 to about 80.

Embodiment 27. The polymer blend of embodiment 1 wherein, after hydrogenation, residual unsaturation in the organic nitrile-based copolymer is from about 0.1% to about 5%, or from about 0.1% to about 4%, or from about 0.1% to about 3%, or from about 0.1% to about 2%, or from about 0.1% to about 1%.

Embodiment 28. The polymer blend of embodiment 27 wherein, after hydrogenation, the organic nitrile-based copolymer is represented by the formula:

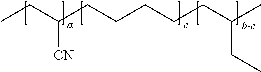

wherein a is a value from 100 to 800, b is a value from 200 to 1200, and c is a value from 0 to 1200; and
wherein the structural units of the residue of acrylonitrile are present in an amount from about 10 wt % to about 60 wt %, based on the total weight of the organic nitrile-based copolymer.

Embodiment 29. The polymer blend of embodiment 1 wherein the organic nitrile-based copolymer has a weight average molecular weight of at least 50,000 g/mol, or at least 75,000 g/mol, or at least 100,000 g/mol, or least 150,000 g/mol, or least 175,000 g/mol, or least 200,000 g/mol, or least 250,000 g/mol.

Embodiment 30. The polymer blend of embodiment 1 wherein the organic nitrile-based copolymer has a weight average molecular weight of no more than 300,000 g/mol, or no more than 290,000 g/mol, or no more than 280,000, or no more than 270,000 g/mol, or no more than 260,000 g/mol, or no more than 250,000 g/mol, or no more than 225,000 g/mol.

Embodiment 31. The polymer blend of embodiment 1 wherein the organic nitrile-based copolymer has a weight average molecular weight of 50,000 to 300,000 g/mol, or 50,000 to 275,000 g/mol, or 50,000 to 250,000 g/mol, or 50,000 to 225,000 g/mol, or 50,000 to 200,000 g/mol, or 100,000 to 300,000 g/mol, or 100,000 to 275,000 g/mol, or 100,000 to 250,000 g/mol, or 100,000 to 225,000 g/mol, or 100,000 to 200,000 g/mol, or 150,000 to 300,000 g/mol, or 150,000 to 275,000 g/mol, or 150,000 to 250,000 g/mol, or 150,000 to 225,000 g/mol, or 150,000 to 200,000 g/mol, or 175,000 to 300,000 g/mol, or 175,000 to 275,000 g/mol, or 175,000 to 250,000 g/mol, or 175,000 to 225,000 g/mol, or 175,000 to 200,000 g/mol.

Embodiment 32. The polymer blend of embodiment 1 wherein the organic nitrile-based copolymer has a weight average molecular weight of from about 50,000 g/mol to about 200,000 g/mol.

Embodiment 33. The polymer blend of embodiment 1 wherein the organic nitrile-based copolymer has a number average molecular weight of at least 30,000 g/mol, or at least 50,000 g/mol, or at least 75,000 g/mol, or at least 100,000 g/mol, or least 150,000 g/mol, or least 175,000 g/mol.

Embodiment 34. The polymer blend of embodiment 1 wherein the organic nitrile-based copolymer has a number average molecular weight of no more than 500,000 g/mol, or no more than 400,000, or no more than 300,000 g/mol, or no more than 200,000 g/mol, or no more than 100,000 g/mol, or no more than 50,000 g/mol, or no more than 30,000 g/mol.

Embodiment 35. The polymer blend of embodiment 1 wherein the organic nitrile-based copolymer has a number average molecular weight of 25,000 to 475,000 g/mol, or 25,000 to 375,000 g/mol, or 25,000 to 275,000 g/mol, or 25,000 to 175,000 g/mol, or 25,000 to 75,000 g/mol, or 50,000 to 475,000 g/mol, or 50,000 to 375,000 g/mol, or 50,000 to 275,000 g/mol, or 50,000 to 175,000 g/mol, or 50,000 to 100,000 g/mol, or 75,000 to 275,000 g/mol, or 75,000 to 4705,000 g/mol, or 75,000 to 375,000 g/mol, or 75,000 to 275,000 g/mol, or 75,000 to 175,000 g/mol, or 75,000 to 125,000 g/mol, or 100,000 to 475,000 g/mol, or 100,000 to 375,000 g/mol, or 100,000 to 275,000 g/mol, or 100,000 to 175,000 g/mol, or 100,000 to 150,000 g/mol.

Embodiment 36. The polymer blend of embodiment 1 wherein the organic nitrile-based copolymer has a number average molecular weight of from about 30,000 g/mol to about 500,000 g/mol.

Embodiment 37. The polymer blend of embodiment 1 wherein the phenol-based polymer, or phenol-based copolymer, has a weight average molecular weight of at least 1,000 g/mol, or least 5,000 g/mol, or least 10,000 g/mol, or least 15,000 g/mol, or least 20,000 g/mol, or least 25,000 g/mol.

Embodiment 38. The polymer blend of embodiment 1 wherein the phenol-based polymer is a phenolic homopolymer.

Embodiment 39. The polymer blend of embodiment 1 wherein the phenol-based copolymer is a coupled phenolic resin.

Embodiment 40. The polymer blend of embodiment 1 wherein the phenol-based polymer, or phenol-based copolymer, has a weight average molecular weight of 1,000 to 100,000 g/mol, or 1,000 to 75,000 g/mol, or 1,000 to 50,000 g/mol, or 1,000 to 25,000 g/mol, or 1,000 to 10,000 g/mol, or 1,000 to 5,000 g/mol, or 1,500 to 100,000 g/mol, or 1,500 to 75,000 g/mol, or 1,500 to 50,000 g/mol, or 1,500 to 25,000 g/mol, or 1,500 to 10,000 g/mol, or 1,500 to 5,000 g/mol, or 2,000 to 100,000 g/mol, or 2,000 to 75,000 g/mol, or 2,000 to 50,000 g/mol, or 2,000 to 25,000 g/mol, or 2,000 to 10,000 g/mol, or 2,000 to 5,000 g/mol, or 1,000 to 30,000 g/mol, or 2,500 to 100,000 g/mol, or 2,500 to 75,000 g/mol, or 2,500 to 50,000 g/mol, or 2,500 to 25,000 g/mol, or 2,500 to 10,000 g/mol, or 2,500 to 5,000 g/mol.

Embodiment 41. The polymer blend of embodiment 1 wherein the phenol-based polymer, or phenol-based copolymer, has a weight average molecular weight of from about 1000 g/mol to about 100,000 g/mol.

Embodiment 42. The polymer blend of embodiment 1 wherein the phenol-based polymer, or phenol-based copolymer, has a number average molecular weight of at least 500 g/mol, or at least 750 g/mol, or at least 1,000 g/mol, or least 5,000 g/mol, or least 10,000 g/mol, or least 15,000 g/mol, or least 20,000 g/mol, or least 25,000 g/mol.

Embodiment 43. The polymer blend of embodiment 1 wherein the phenol-based polymer, or phenol-based copolymer, has a number average molecular weight of no more than 50,000 g/mol, or no more than 40,000 g/mol, or no more than 30,000, or no more than 25,000 g/mol, or no more than 20,000 g/mol, or no more than 15,000 g/mol, or no more than 10,000 g/mol.

Embodiment 44. The polymer blend of embodiment 1 wherein the phenol-based polymer, or phenol-based copolymer, has a number average molecular weight of 500 to 50,000, or 500 to 40,000 g/mol, or 500 to 25,000 g/mol, or 500 to 20,000 g/mol, or 500 to 15,000 g/mol, or 500 to 10,000 g/mol, or 500 to 5,000 g/mol, or 500 to 1,000 g/mol, or 750 to 50,000, or 750 to 40,000 g/mol, or 750 to 25,000 g/mol, or 750 to 20,000 g/mol, or 750 to 15,000 g/mol, or 750 to 10,000 g/mol, or 750 to 5,000 g/mol, or 750 to 1,000 g/mol, or 1,000 to 50,000, or 1,000 to 40,000 g/mol, or 1,000 to 25,000 g/mol, or 1,000 to 20,000 g/mol, or 1,000 to 15,000 g/mol, or 1,000 to 10,000 g/mol, or 1,000 to 5,000 g/mol, or 1,500 to 50,000, or 1,500 to 40,000 g/mol, or 1,500 to 25,000 g/mol, or 1,500 to 20,000 g/mol, or 1,500 to 15,000 g/mol, or 1,500 to 10,000 g/mol, or 1,500 to 5,000 g/mol.

Embodiment 45. The polymer blend of embodiment 1 wherein the phenol-based polymer, or phenol-based copolymer, has a number average molecular weight of from about 500 g/mol to about 50,000 g/mol.

Embodiment 46. A synergistic dispersant comprising the polymer blend of embodiment 1.

Embodiment 47. The synergistic dispersant of embodiment 46, when present in a conductive carbon dispersion, the conductive carbon dispersion exhibits lower viscosity as compared to a conductive carbon dispersion in which only the organic nitrile-based copolymer, or the phenol-based polymer, or the phenol-based copolymer, is present.

Embodiment 48. The synergistic dispersant of embodiment 46, when present in an electrode slurry composition, the electrode slurry composition exhibits lower viscosity as compared to an electrode slurry composition in which only the organic nitrile-based copolymer, or the phenol-based polymer, or the phenol-based copolymer, is present.

Embodiment 49. A dispersant concentrate comprising the synergistic dispersant of embodiment 46, and a solvent.

Embodiment 50. The dispersant concentrate of embodiment 49, wherein the solvent is selected from the group consisting of N-methyl-2-pyrrolidone, water, toluene, xylene, isopropanol, ethyl acetate, butyl butyrate, and combinations thereof.

Embodiment 51. The dispersant concentrate of embodiment 49, wherein the synergistic dispersant, is present in an amount from about 10 to about 80 wt %, or from about 20 to about 60 wt %, or from about 40 to about 60 wt %; and the solvent is present in an amount from about 20 to about 90 wt %, or from about 40 to about 80 wt %, or from about 40 to about 60 wt %, based on the total weight of the dispersant concentrate.

Embodiment 52. A conductive carbon dispersion comprising the synergistic dispersant of embodiments 46-48, or the dispersant concentrate of embodiments 49-51, a conductive carbon, and a solvent.

Embodiment 53. The conductive carbon dispersion of embodiment 52, wherein the conductive carbon is selected from the group consisting of carbon nanotubes, graphene, carbon black, graphite, and combinations thereof.

Embodiment 54. The conductive carbon dispersion of embodiment 52, wherein the synergistic dispersant, or dispersant concentrate, is present in an amount from about 0.1 to about 6 wt %, or from about 0.1 to about 3 wt %, or from about 0.1 to about 1 wt %; the conductive carbon is present in an amount from about 0.5 to about 12 wt %, or from about 0.5 to about 4 wt %, or from about 0.5 to about 1 wt %; and the solvent is present in an amount from about 82 to about 99.5 wt %, or from about 82 to about 98 wt %, or from about 82 to about 95 wt %; based on the total weight of the conductive carbon dispersion.

Embodiment 55. The conductive carbon dispersion of embodiment 52, wherein the solvent is selected from the group consisting of N-methyl-2-pyrrolidone, water, toluene, xylene, isopropanol, ethyl acetate, butyl butyrate, and combinations thereof.

Embodiment 56. An electrode slurry composition for producing a battery positive electrode comprising the conductive carbon dispersion of any one of embodiments 52-55, an electrode active material, and a binder.

Embodiment 57. The electrode slurry composition of embodiment 56, wherein the electrode active material is selected from the group consisting of lithium iron phosphate (LiFePO₄), lithium manganese iron phosphate (LMFP), lithium cobalt oxide (LiCoO₂), lithium manganese oxide (LiMn₂O₄), lithium manganese oxide (Li₂MnO₃), lithium nickel manganese cobalt oxide (LiNi_{0.33}Mn_{0.33}Co_{0.33}O₂), lithium nickel manganese cobalt oxide (LiNi_{0.6}Mn_{0.2}Co_{0.2}O₂), and lithium nickel manganese cobalt oxide (LiNi_{0.8}Mn_{0.1}Co_{0.1}O₂).

Embodiment 58. The electrode slurry composition of embodiment 56, wherein the electrode active material is selected from the group consisting of a lithium oxide containing one or more metals selected from the group consisting of cobalt, manganese, nickel, and aluminum; a lithium oxide selected from the group consisting of a lithium-manganese-based oxide, LiMnO₂, and LiMn₂O; a lithium-cobalt-based oxide, and LiCoO₂; a lithium-nickel-based oxide and LiNiO₂; a lithium-nickel-manganese-based oxide, LiNi_{1-Y1}Mn_{Y1}O₂ wherein 0<Y1<1, LiNi_{Z1}Mn_{2-Z1}O₄ wherein 0<Z1<2; a lithium-nickel-cobalt-based oxide, LiNi_{1-Y2}Co_{Y2}O₂ wherein 0<Y2<1; a lithium-manganese-cobalt-based oxide, LiCo_{1-Y3}Mn_{Y3}O₂ wherein 0<Y3<1, LiMn_{2-Z2}Co_{Z2}O₄ wherein 0<Z2<2; a lithium-nickel-cobalt-manganese-based oxide, Li(Ni_{P1}Co_{Q1}Mn_{R1})O₂ wherein 0<P1<1, 0<Q1<1, 0<R1<1, P1+Q1+R1=1, Li(Ni_{P2}Co_{Q2}Mn_{R2})O₄ wherein 0<P2<2, 0<Q2<2, 0<R2<2, P2+Q2+R2=2; and a lithium-nickel-cobalt-manganese-other metal (M) oxide, Li(Ni_{P3}Co_{Q3}Mn_{R3}M¹ s)O₂ wherein M¹ is selected from the group consisting of Al, Cu, Fe, V, Cr, Ti, Zr, Zn, Ta, Nb, Mg, B, W and Mo, and P3, Q3, R3, and S are each an atomic fraction of independent elements, and 0<P3<1, 0<Q3<1, 0<R3<1, 0<S<1, P3+Q3+R3+S=1; and combinations thereof.

Embodiment 59. The electrode slurry composition of embodiment 56, wherein the binder is selected from the group consisting of polyvinylidene fluoride (PVDF), a vinylidene fluoride-hexafluoropropylene copolymer (PVDF-co-HFP), polyvinyl alcohol, polyacrylonitrile, carboxymethyl cellulose (CMC), starch, hydroxypropyl cellulose, regenerated cellulose, polyvinylpyrrolidone, polytetrafluoroethylene, polyethylene, polypropylene, an ethylene-propylene-diene monomer (EPDM), a sulfonated-EPDM, styrene-butadiene rubber (SBR), fluorine rubber, or copolymers thereof, and combinations thereof.

Embodiment 60. The electrode slurry composition of embodiment 56, wherein the electrode active material is lithium iron phosphate (LFP) and is present in an amount of about 100 parts by weight; the conductive carbon is present in an amount from about 0.2 to about 10 parts by weight, or from about 0.5 to about 2 parts by weight, or from about 0.5 to about 1.5 parts by weight; the dispersant is present in an amount from about 0.02 to about 0.5 parts by weight, or from about 0.05 to about 0.02 parts by weight, or from about 0.1 to about 0.2 parts by weight; the binder is present in an amount from about 0.5 to about 5 parts by weight, or from about 1.5 to about 2 parts by weight, or from about 0.5 to about 2 parts by weight; and the solvent is present in an amount from about 25 to about 75 parts by weight, or from about 35 to about 70 parts by weight, or from about 45 to about 65 parts by weight.

Embodiment 61. The electrode slurry composition of embodiment 56, wherein the electrode active material is lithium nickel manganese cobalt oxide (NMC) and is present in an amount of about 100 parts by weight, or from about 97 to 99 parts by weight, or from about 97 to about 98.3 parts by weight; the conductive carbon is carbon nanotubes and is present in an amount from about 0.2 to about 10 parts by weight, or from about 0.5 to about 2 parts by weight, or from about 0.5 to about 1.5 parts by weight; the dispersant is present in an amount from about 0.02 to about 0.5 parts by weight, or from about 0.1 to about 1 parts by weight, or from about 0.1 to about 0.25 parts by weight; the binder is present in an amount from about 0.5 to about 5 parts by weight, or from about 0.5 to about 1.5 parts by weight, or from about 0.5 to about 0.7 parts by weight; and the solvent is present in an amount from about 25 to about 75 parts by weight, or from about 35 to about 70 parts by weight, or from about 45 to about 65 parts by weight.

Embodiment 62. A positive electrode comprising an electrical current collector and a film formed on the electrical current collector, wherein the film is deposited from the electrode slurry composition of any one of embodiments 56-61, and the solvent subsequently removed.

Embodiment 63. An electrical storage device comprising the positive electrode of embodiment 62, a negative electrode, a separator, and an electrolyte.

Embodiment 64. The electrical storage device of embodiment 63 comprising a cell, a battery, a battery pack, a secondary battery, or a capacitor.

Embodiment 65. The synergistic dispersants of embodiments 46-48, when used in a conductive carbon dispersion, the conductive carbon dispersion exhibits lower viscosity and/or increased solids content, as compared to a control conductive carbon dispersion having polyvinyl pyrrolidone (PVP) dispersant.

Embodiment 66. The synergistic dispersants of embodiments 46-48, when used in a cathode slurry formulation, the cathode slurry formulation exhibits lower viscosity, as compared to a control cathode slurry formulation having polyvinyl pyrrolidone (PVP) dispersant, at high solid content.

Embodiment 67. The conductive carbon dispersion of embodiments 52-55 which has a viscosity (Pa·s) from about 1 to about 80 Pa·s, and a solids content (wt %) from about 50 to about 80 wt %, at a shear rate (1/s) from about 0.1 to about 100 1/s.

Embodiment 68. The electrode slurry composition of embodiments 56-61 which has a viscosity (Pa·s) from about 5 to about 30 Paes, and a solids content (wt %) from about 50 to about 80 wt %, at a shear rate (1/s) from about 0.1 to about 100 1/s.

### EXAMPLES

This disclosure may be further understood by reference to the following (non-limiting) examples. In the following Examples, the properties of certain components or the composition itself are described using certain terms of art, as defined below. In the Examples, all parts are parts by weight, unless otherwise noted.

CNT dispersions having different dispersants were prepared with a high-speed Silverson mixer with an emulsion workhead. The CNT dispersions contained the following ingredients: CNT 1.0%, dispersant 1.0%, NMP 98.0% by weight. The contents were mixed in a jar at 2000 rpm for 5 min, 4000 rpm for 5 min, 6000 rpm for 5 min, and 8000 rpm for 5 min. Rheology of the resulting CNT dispersions was measured with Anton Paar MCR 302e rheometer. The dispersants used in the CNT dispersions are shown in the Table E below.

TABLE E

| Dispersant | Chemical Description |
|---|---|
| 1 (comparative | PVPL: Poly(4-vinylphenol), M_{w} = ~25,000 |
| example 1) | |
| 2 (comparative | PVP: Polyvinylpyrrolidone K-30 |
| example 2) | |
| 3 (comparative | HNBR: Hydrogenated nitrile-butadiene rubber, |
| example 3) | acrylonitrile = 30%, M_{w} = 210,000 |
| 4 (inventive example 1) | HNBR (30 wt %) + PVPL (70 wt %) |
| 5 (inventive example 2) | HNBR (50 wt %) + PVPL (50 wt %) |
| 6 (inventive example 3) | HNBR (70 wt %) + PVPL (30 wt %) |

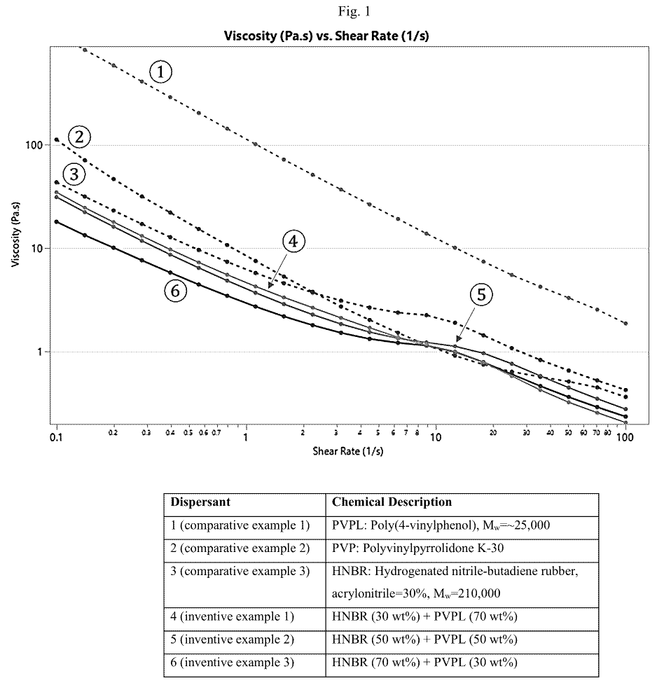

FIG. 1 graphically depicts a comparison of rheology of CNT dispersions using different dispersants in Table E, particularly viscosity relative to shear rate for comparative and inventive dispersants in Table E in CNT dispersions.

LFP cathode slurries having different dispersants were prepared with a centrifugal planetary Thinky mixer. The LFP cathode slurries contained the following ingredients: LFP 100 parts, PVDF 2 parts, carbon black (CB) 1.5 parts, dispersant 0.2 parts by weight, NMP is balanced to make a final slurry of 65% solid content (LFP+PVDF+CB+dispersant). PVDF, dispersant, and NMP were mixed at 2000 rpm for 2 min, then CB was added and mixed at 2000 rpm for 15 min. Finally LFP was added and mixed at 2000 rpm for 15 min to make LFP cathode slurry. Rheology of the resulting slurry was measured with Anton Paar MCR 302e rheometer. The dispersants used in the LFP cathode slurries are shown in the Table F below.

TABLE F

| Dispersant | Chemical Description |
|---|---|
| 1 (comparative | No dispersant |
| example 1) | |
| 2 (comparative | PVPL: Poly(4-vinylphenol), M_{w} = ~25,000 |
| example 1) | |
| 3 (comparative | PVP: Polyvinylpyrrolidone K-30 |
| example 3) | |
| 4 (comparative | HNBR: Hydrogenated nitrile-butadiene rubber, |
| example 2) | acrylonitrile = 30%, M_{w} = 210,000 |
| 5 (inventive | HNBR (50 wt %) + PVPL (50 wt %) |
| example 2) | |

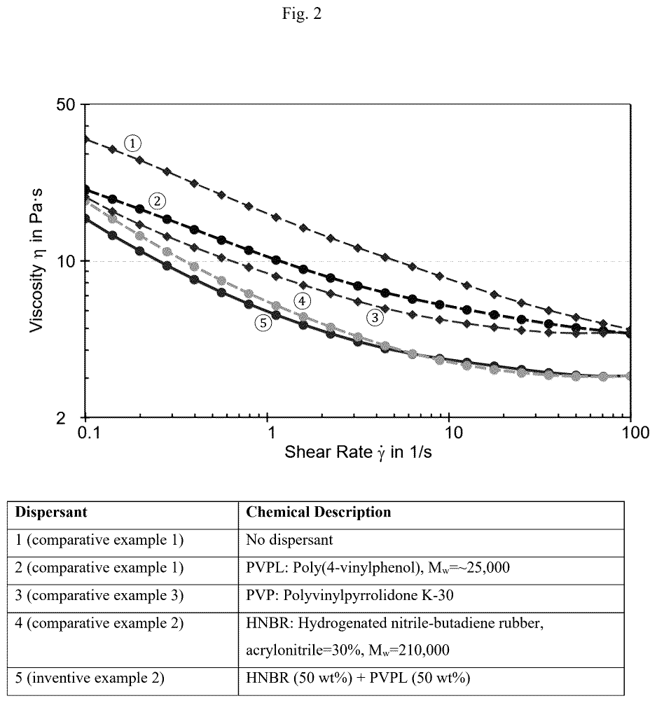

FIG. 2 graphically depicts a comparison of rheology of LFP cathode slurries using different dispersants in Table F, particularly viscosity relative to shear rate for comparative and inventive dispersants in Table F in LFP cathode slurries.

### PCT and EP Clauses

1. A polymer blend comprising:
an organic nitrile-based copolymer; and
a phenol-based polymer or a phenol-based copolymer;
wherein the organic nitrile-based copolymer comprises structural units comprising the residue of a substituted or unsubstituted, unsaturated organic nitrile monomer; and structural units comprising the residue of a substituted or unsubstituted, conjugated diene monomer;
wherein the phenol-based polymer comprises structural units comprising the residue of a substituted or unsubstituted, unsaturated phenolic monomer;
wherein the phenol-based copolymer comprises structural units comprising the residue of a substituted or unsubstituted, unsaturated coupled phenolic resin; and
wherein the organic nitrile-based copolymer is present in an amount from about 0.5 wt % to about 99.5 wt %, and the phenol-based polymer, or the phenol-based copolymer, is present in an amount from about 0.5 wt % to about 99.5 wt %, based on the total weight of the polymer blend.

2. The polymer blend of clause 1 wherein the organic nitrile-based copolymer is present in an amount from about 1 wt % to about 99 wt %, or from about 1 wt % to about 90 wt %, or from about 1 wt % to about 80 wt %, or from about 1 wt % to about 70 wt %, or from about 1 wt % to about 60 wt %, or from about 1 wt % to about 50 wt %, or from about 1 wt % to about 40 wt %, or from about 1 wt % to about 30 wt %, or from about 1 wt % to about 20 wt %, or from about 1 wt % to about 10 wt %, based on the total weight of the polymer blend; and wherein the phenol-based polymer, or phenol-based copolymer, is present in an amount from about 1 wt % to about 99 wt %, or from about 1 wt % to about 90 wt %, or from about 1 wt % to about 80 wt %, or from about 1 wt % to about 70 wt %, or from about 1 wt % to about 60 wt %, or from about 1 wt % to about 50 wt %, or from about 1 wt % to about 40 wt %, or from about 1 wt % to about 30 wt %, or from about 1 wt % to about 20 wt %, or from about 1 wt % to about 10 wt %, based on the total weight of the polymer blend; or wherein the weight ratio of the organic nitrile-based copolymer to the phenol-based polymer, or phenol-based copolymer, in the polymer blend is from about 1:99 to about 99:1, or from about 1:99 to about 90:10, or from about 1:99 to about 80:20, or from about 1:99 to about 70:30, or from about 1:99 to about 60:40, or from about 1:99 to about 50:50, or from about 1:99 to about 40:60, or from about 1:99 to about 30:70, or from about 1:99 to about 20:80, or from about 1:99 to about 10:90.

3. The polymer blend of clauses 1 and 2 wherein the substituted or unsubstituted, unsaturated organic nitrile monomer is represented by the formula:

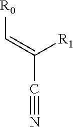

wherein R₀, R₁ is independently hydrogen or an alkyl group having from 1 to 10 carbon atoms; and
wherein the substituted or unsubstituted, conjugated diene monomer is substituted or unsubstituted butadiene monomer, represented by the formula:

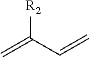

wherein R₂ is hydrogen or methyl.

4. The polymer blend of clauses 1-3 wherein the organic nitrile-based copolymer comprises structural units of the residue of acrylonitrile and structural units of the residue of butadiene, and is represented by the formula:

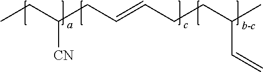

wherein a is a value from 100 to 800, b is a value from 200 to 1200, and c is a value from 0 to 1200; and
wherein the structural units of the residue of acrylonitrile are present in an amount from about 10 wt % to about 60 wt %, based on the total weight of the organic nitrile-based copolymer;
wherein the phenol-based polymer is a phenolic homopolymer represented by the formula:

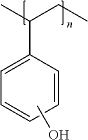

wherein n is a value from about 5 to about 2000; and
wherein the phenol-based copolymer is a coupled phenolic resin represented by the formula:

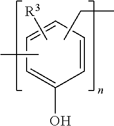

wherein R₃ is hydrogen or an alkyl group having from 1 to 20 carbon atoms, and n is a value from 5 to 2000.

5. The polymer blend of clauses 1~4 wherein the coupled phenolic resin comprises a substituted or unsubstituted phenolic compound coupled with a coupling agent; wherein the coupling agent is selected from the group consisting of a substituted or unsubstituted aldehyde, sulfur, silane or combinations thereof; or is formaldehyde; and wherein the coupling ratio of the coupling agent to the phenolic compound, is from about 1.2:1 to about 0.8:1, or is 1:1.

6. The polymer blend of clauses 1-5 wherein the structural units comprising the residue of a substituted or unsubstituted, unsaturated organic nitrile monomer are present in the organic nitrile-based copolymer in an amount from about 1 wt % to about 99 wt %, or from about 1 wt % to about 90 wt %, or from about 1 wt % to about 80 wt %, or from about 1 wt % to about 70 wt %, or from about 1 wt % to about 60 wt %, or from about 1 wt % to about 50 wt %, or from about 1 wt % to about 40 wt %, or from about 1 wt % to about 30 wt %, or from about 1 wt % to about 20 wt %, or from about 1 wt % to about 10 wt %, based on the total weight of the organic nitrile-based copolymer; or in an amount from about 25 wt % to about 50 wt %, or from about 30 wt % to about 45 wt %, or from about 30 wt % to about 40 wt %, based on the total weight of the organic nitrile-based copolymer; and wherein the structural units comprising the residue of a substituted or unsubstituted, conjugated diene monomer are present in the organic nitrile-based copolymer in an amount from about 1 wt % to about 99 wt %, or from about 10 wt % to about 95 wt %, or from about 20 wt % to about 90 wt %, or from about 30 wt % to about 85 wt %, or from about 40 wt % to about 80 wt %, or from about 50 wt % to about 80 wt %, or from about 55 wt % to about 75 wt %, or from about 60 wt % to about 70 wt %, based on the total weight of the organic nitrile-based copolymer.

7. The polymer blend of clauses 1-6 wherein the weight ratio of the structural units comprising the residue of a substituted or unsubstituted, unsaturated organic nitrile monomer to the structural units comprising the residue of a substituted or unsubstituted, conjugated diene monomer in the organic nitrile-based copolymer is from about 1:99 to about 99:1, or from about 1:99 to about 90:10, or from about 1:99 to about 80:20, or from about 1:99 to about 70:30, or from about 1:99 to about 60:40, or from about 1:99 to about 50:50, or from about 1:99 to about 40:60, or from about 1:99 to about 30:70, or from about 1:99 to about 20:80, or from about 1:99 to about 10:90; and/or wherein the organic nitrile-based copolymer has a density between about 0.5-2.0 g/cm³, or between about 0.5-1.5 g/cm³, or between about 0.5-1.25 g/cm³, or between about 0.75-1.0 g/cm³; and/or wherein the organic nitrile-based copolymer has a Mooney viscosity (ML(1+4) at 100° C.) from about 30 to about 150, or from about 30 to about 100, or from about 30 to about 90, or from about 30 to about 80; and/or wherein, after hydrogenation, residual unsaturation in the organic nitrile-based copolymer is from about 0.1% to about 5%, or from about 0.1% to about 4%, or from about 0.1% to about 3%, or from about 0.1% to about 2%, or from about 0.1% to about 1%.

8. The polymer blend of clauses 1-7 wherein, after hydrogenation, the organic nitrile-based copolymer is represented by the formula:

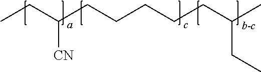

wherein a is a value from 100 to 800, b is a value from 200 to 1200, and c is a value from 0 to 1200; and
wherein the structural units of the residue of acrylonitrile are present in an amount from about 10 wt % to about 60 wt %, based on the total weight of the organic nitrile-based copolymer.

9. The polymer blend of clauses 1-8 wherein the organic nitrile-based copolymer has a weight average molecular weight of 50,000 to 300,000 g/mol, or 50,000 to 275,000 g/mol, or 50,000 to 250,000 g/mol, or 50,000 to 225,000 g/mol, or 50,000 to 200,000 g/mol, or 100,000 to 300,000 g/mol, or 100,000 to 275,000 g/mol, or 100,000 to 250,000 g/mol, or 100,000 to 225,000 g/mol, or 100,000 to 200,000 g/mol, or 150,000 to 300,000 g/mol, or 150,000 to 275,000 g/mol, or 150,000 to 250,000 g/mol, or 150,000 to 225,000 g/mol, or 150,000 to 200,000 g/mol, or 175,000 to 300,000 g/mol, or 175,000 to 275,000 g/mol, or 175,000 to 250,000 g/mol, or 175,000 to 225,000 g/mol, or 175,000 to 200,000 g/mol; or wherein the organic nitrile-based copolymer has a number average molecular weight of from about 30,000 g/mol to about 500,000 g/mol.

10. The polymer blend of clauses 1-9 wherein the phenol-based polymer, or phenol-based copolymer, has a weight average molecular weight of 1,000 to 100,000 g/mol, or 1,000 to 75,000 g/mol, or 1,000 to 50,000 g/mol, or 1,000 to 25,000 g/mol, or 1,000 to 10,000 g/mol, or 1,000 to 5,000 g/mol, or 1,500 to 100,000 g/mol, or 1,500 to 75,000 g/mol, or 1,500 to 50,000 g/mol, or 1,500 to 25,000 g/mol, or 1,500 to 10,000 g/mol, or 1,500 to 5,000 g/mol, or 2,000 to 100,000 g/mol, or 2,000 to 75,000 g/mol, or 2,000 to 50,000 g/mol, or 2,000 to 25,000 g/mol, or 2,000 to 10,000 g/mol, or 2,000 to 5,000 g/mol, or 1,000 to 30,000 g/mol, or 2,500 to 100,000 g/mol, or 2,500 to 75,000 g/mol, or 2,500 to 50,000 g/mol, or 2,500 to 25,000 g/mol, or 2,500 to 10,000 g/mol, or 2,500 to 5,000 g/mol; or wherein the phenol-based polymer, or phenol-based copolymer, has a weight average molecular weight of from about 1000 g/mol to about 100,000 g/mol; or wherein the phenol-based polymer, or phenol-based copolymer, has a number average molecular weight of 500 to 50,000, or 500 to 40,000 g/mol, or 500 to 25,000 g/mol, or 500 to 20,000 g/mol, or 500 to 15,000 g/mol, or 500 to 10,000 g/mol, or 500 to 5,000 g/mol, or 500 to 1,000 g/mol, or 750 to 50,000, or 750 to 40,000 g/mol, or 750 to 25,000 g/mol, or 750 to 20,000 g/mol, or 750 to 15,000 g/mol, or 750 to 10,000 g/mol, or 750 to 5,000 g/mol, or 750 to 1,000 g/mol, or 1,000 to 50,000, or 1,000 to 40,000 g/mol, or 1,000 to 25,000 g/mol, or 1,000 to 20,000 g/mol, or 1,000 to 15,000 g/mol, or 1,000 to 10,000 g/mol, or 1,000 to 5,000 g/mol, or 1,500 to 50,000, or 1,500 to 40,000 g/mol, or 1,500 to 25,000 g/mol, or 1,500 to 20,000 g/mol, or 1,500 to 15,000 g/mol, or 1,500 to 10,000 g/mol, or 1,500 to 5,000 g/mol; or wherein the phenol-based polymer, or phenol-based copolymer, has a number average molecular weight of from about 500 g/mol to about 50,000 g/mol.

11. A synergistic dispersant comprising the polymer blend of any of clauses 1-10, wherein, when present in a conductive carbon dispersion, the conductive carbon dispersion exhibits lower viscosity as compared to a conductive carbon dispersion in which only the organic nitrile-based copolymer, or the phenol-based polymer, or the phenol-based copolymer, is present; or when present in an electrode slurry composition, the electrode slurry composition exhibits lower viscosity as compared to an electrode slurry composition in which only the organic nitrile-based copolymer, or the phenol-based polymer, or the phenol-based copolymer, is present.

12. A dispersant concentrate comprising the synergistic dispersant of clause 11, and a solvent; wherein the synergistic dispersant is present in an amount from about 10 to about 80 wt %, or from about 20 to about 60 wt %, or from about 40 to about 60 wt %; and the solvent is present in an amount from about 20 to about 90 wt %, or from about 40 to about 80 wt %, or from about 40 to about 60 wt %, based on the total weight of the dispersant concentrate; wherein the solvent is selected from the group consisting of N-methyl-2-pyrrolidone, water, toluene, xylene, isopropanol, ethyl acetate, butyl butyrate, and combinations thereof.

13. A conductive carbon dispersion comprising the synergistic dispersant of clause 11, or the dispersant concentrate of clause 12, a conductive carbon, and a solvent.

14. The conductive carbon dispersion of clause 13, wherein the conductive carbon is selected from the group consisting of carbon nanotubes, graphene, carbon black, graphite, and combinations thereof; and wherein the solvent is selected from the group consisting of N-methyl-2-pyrrolidone, water, toluene, xylene, isopropanol, ethyl acetate, butyl butyrate, and combinations thereof.

15. The conductive carbon dispersion of clause 13, wherein the synergistic dispersant, or dispersant concentrate, is present in an amount from about 0.1 to about 6 wt %, or from about 0.1 to about 3 wt %, or from about 0.1 to about 1 wt %; the conductive carbon is present in an amount from about 0.5 to about 12 wt %, or from about 0.5 to about 4 wt %, or from about 0.5 to about 1 wt %; and the solvent is present in an amount from about 82 to about 99.5 wt %, or from about 82 to about 98 wt %, or from about 82 to about 95 wt %; based on the total weight of the conductive carbon dispersion.

16. An electrode slurry composition for producing a battery positive electrode comprising the conductive carbon dispersion of any of clauses 13-15, an electrode active material, and a binder.

17. The electrode slurry composition of clause 16, wherein the electrode active material is selected from the group consisting of lithium iron phosphate (LiFePO₄), lithium manganese iron phosphate (LiMnₓFe₍₁₋ₓ₎PO₄), lithium cobalt oxide (LiCoO₂), lithium manganese oxide (LiMn₂O₄), lithium manganese oxide (Li₂MnO₃), lithium nickel manganese cobalt oxide (LiNi_{0.33}Mn_{0.33}Co_{0.33}O₂), lithium nickel manganese cobalt oxide (LiNi_{0.6}Mn_{0.2}Co_{0.202}), and lithium nickel manganese cobalt oxide (LiNi_{0.8}Mn_{0.1}Co_{0.1}O₂); or from the group consisting of a lithium oxide containing one or more metals selected from the group consisting of cobalt, manganese, nickel, and aluminum; a lithium oxide selected from the group consisting of a lithium-manganese-based oxide, LiMnO₂, and LiMn₂O; a lithium-cobalt-based oxide, and LiCoO₂; a lithium-nickel-based oxide and LiNiO₂; a lithium-nickel-manganese-based oxide, LiNi_{1-Y1}Mn_{Y1}O₂ wherein 0<Y1<1, LiNi_{Z1}Mn_{2-Z1}O₄ wherein 0<Z1<2; a lithium-nickel-cobalt-based oxide, LiNi_{1-Y2}Co_{Y2}O₂ wherein 0<Y2<1; a lithium-manganese-cobalt-based oxide, LiCo_{1-Y3}Mn_{Y3}O₂ wherein 0<Y3<1, LiMn_{2-Z2}Co_{Z2}O₄ wherein 0<Z2<2; a lithium-nickel-cobalt-manganese-based oxide, Li(Ni_{P1}Co_{Q1}Mn_{R1})O₂ wherein 0<P1<1, 0<Q1<1, 0<R1<1, P1+Q1+R1=1, Li(Ni_{P2}Co_{Q2}Mn_{R2})O₄ wherein 0<P2<2, 0<Q2<2, 0<R2<2, P2+Q2+R2=2; and a lithium-nickel-cobalt-manganese-other metal (M) oxide, Li(Ni_{P3}Co_{Q3}Mn_{R3}M¹ s)O₂ wherein M¹ is selected from the group consisting of Al, Cu, Fe, V, Cr, Ti, Zr, Zn, Ta, Nb, Mg, B, W and Mo, and P3, Q3, R3, and S are each an atomic fraction of independent elements, and 0<P3<1, 0<Q3<1, 0<R3<1, 0<S<1, P3+Q3+R3+S=1; and combinations thereof.

18. A positive electrode comprising an electrical current collector and a film formed on the electrical current collector, wherein the film is deposited from the electrode slurry composition of any of clauses 16 and 17, and the solvent subsequently removed; or an electrical storage device comprising the positive electrode, a negative electrode, a separator, and an electrolyte; wherein the electrical storage device comprises a cell, a battery, a battery pack, a secondary battery, or a capacitor.

19. The conductive carbon dispersion of any of clauses 13-15 which has a viscosity (Pa·s) from about 1 to about 80 Pa·s, and a solids content (wt %) from about 50 to about 80 wt %, at a shear rate (1/s) from about 0.1 to about 100 1/s; and exhibits lower viscosity and/or increased solids content, as compared to a control conductive carbon dispersion having polyvinyl pyrrolidone (PVP) dispersant; or the electrode slurry composition of any of clauses 16 and 17 which has a viscosity (Pa·s) from about 5 to about 30 Paes, and a solids content (wt %) from about 50 to about 80 wt %, at a shear rate (1/s) from about 0.1 to about 100 1/s; and exhibits lower viscosity, as compared to a control electrode slurry formulation having polyvinyl pyrrolidone (PVP) dispersant, at high solid content.

The disclosures of all patents, articles and other materials described herein are hereby incorporated, in their entirety, into this specification by reference. A description of a composition comprising, consisting of, or consisting essentially of multiple specified components, as presented herein and in the appended claims, should be construed to also encompass compositions made by admixing said multiple specified components. The principles, preferred embodiments, and modes of operation of the present disclosure have been described in the foregoing specification. What applicants submit is their disclosure, however, is not to be construed as limited to the particular embodiments disclosed, since the disclosed embodiments are regarded as illustrative rather than limiting. Changes may be made by those skilled in the art without departing from the spirit of the disclosure.

What is claimed is:

1. A polymer blend comprising:
an organic nitrile-based copolymer; and
a phenol-based polymer or a phenol-based copolymer;
wherein the organic nitrile-based copolymer comprises structural units comprising the residue of a substituted or unsubstituted, unsaturated organic nitrile monomer; and structural units comprising the residue of a substituted or unsubstituted, conjugated diene monomer;
wherein the phenol-based polymer comprises structural units comprising the residue of a substituted or unsubstituted, unsaturated phenolic monomer;
wherein the phenol-based copolymer comprises structural units comprising the residue of a substituted or unsubstituted, unsaturated coupled phenolic resin; and
wherein the organic nitrile-based copolymer is present in an amount from about 0.5 wt % to about 99.5 wt %, and the phenol-based polymer, or the phenol-based copolymer, is present in an amount from about 0.5 wt % to about 99.5 wt %, based on the total weight of the polymer blend.

2. The polymer blend of claim 1 wherein the organic nitrile-based copolymer is present in an amount from about 1 wt % to about 99 wt %, based on the total weight of the polymer blend; and wherein the phenol-based polymer, or phenol-based copolymer, is present in an amount from about 1 wt % to about 99 wt %, based on the total weight of the polymer blend.

3. The polymer blend of claim 1 wherein the weight ratio of the organic nitrile-based copolymer to the phenol-based polymer, or phenol-based copolymer, in the polymer blend is from about 1:99 to about 99:1.

4. The polymer blend of claim 1 wherein the substituted or unsubstituted, unsaturated organic nitrile monomer is represented by the formula: 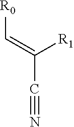
wherein R₀, and R₁ are independently hydrogen or an alkyl group having from 1 to 10 carbon atoms; and
wherein the substituted or unsubstituted, conjugated diene monomer is substituted or unsubstituted butadiene monomer.

5. The polymer blend of claim 1 wherein the organic nitrile-based copolymer comprises structural units of the residue of acrylonitrile and structural units of the residue of butadiene, and is represented by the formula: 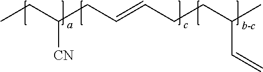
wherein a is a value from 100 to 800, b is a value from 200 to 1200, and c is a value from 0 to 1200; and
wherein the structural units of the residue of acrylonitrile are present in an amount from about 10 wt % to about 60 wt %, based on the total weight of the organic nitrile-based copolymer;
wherein the phenol-based polymer is a phenolic homopolymer represented by the formula: 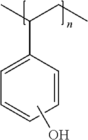
wherein n is a value from about 5 to about 2000; and
wherein the phenol-based copolymer is a coupled phenolic resin represented by the formula: 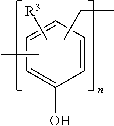
wherein R₃ is hydrogen or an alkyl group having from 1 to 20 carbon atoms, and n is a value from 5 to 2000.

6. The polymer blend of claim 1 wherein the coupled phenolic resin comprises a substituted or unsubstituted phenolic compound coupled with a coupling agent; wherein the coupling agent is selected from the group consisting of a substituted or unsubstituted aldehyde, sulfur, silane and combinations thereof.

7. The polymer blend of claim 1 wherein the coupling ratio of the coupling agent to the phenolic compound, is from about 1.2:1 to about 0.8:1.

8. The polymer blend of claim 1 wherein the structural units comprising the residue of a substituted or unsubstituted, unsaturated organic nitrile monomer are present in the organic nitrile-based copolymer in an amount from about 1 wt % to about 99 wt %, based on the total weight of the organic nitrile-based copolymer; and wherein the structural units comprising the residue of a substituted or unsubstituted, conjugated diene monomer are present in the organic nitrile-based copolymer in an amount from about 1 wt % to about 99 wt %, based on the total weight of the organic nitrile-based copolymer.

9. The polymer blend of claim 1 wherein the weight ratio of the structural units comprising the residue of a substituted or unsubstituted, unsaturated organic nitrile monomer to the structural units comprising the residue of a substituted or unsubstituted, conjugated diene monomer in the organic nitrile-based copolymer is from about 1:99 to about 99:1; and/or wherein the organic nitrile-based copolymer has a density between about 0.5-2.0 g/cm³; and/or wherein the organic nitrile-based copolymer has a Mooney viscosity (ML1+4 at 100° C.) from about 30 to about 150; and/or wherein, after hydrogenation, residual unsaturation in the organic nitrile-based copolymer is from about 0.1% to about 5%.

10. The polymer blend of claim 1 wherein, after hydrogenation, the organic nitrile-based copolymer is represented by the formula: 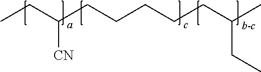
wherein a is a value from 100 to 800, b is a value from 200 to 1200, and c is a value from 0 to 1200; and
wherein the structural units of the residue of acrylonitrile are present in an amount from about 10 wt % to about 60 wt %, based on the total weight of the organic nitrile-based copolymer.

11. The polymer blend of claim 1 wherein the organic nitrile-based copolymer has a weight average molecular weight of 50,000 to 300,000 g/mol.

12. The polymer blend of claim 1 wherein the organic nitrile-based copolymer has a number average molecular weight of 25,000 to 475,000 g/mol.

13. The polymer blend of claim 1 wherein the phenol-based polymer, or phenol-based copolymer, has a weight average molecular weight of 1,000 to 100,000 g/mol.

14. The polymer blend of claim 1 wherein the phenol-based polymer, or phenol-based copolymer, has a number average molecular weight of 500 to 50,000.

15. A synergistic dispersant comprising the polymer blend of claim 1.

16. The synergistic dispersant of claim 15, when present in a conductive carbon dispersion, the conductive carbon dispersion exhibits lower viscosity as compared to a conductive carbon dispersion in which only the organic nitrile-based copolymer, or the phenol-based polymer, or the phenol-based copolymer, is present; or when present in an electrode slurry composition, the electrode slurry composition exhibits lower viscosity as compared to an electrode slurry composition in which only the organic nitrile-based copolymer, or the phenol-based polymer, or the phenol-based copolymer, is present.

17. A dispersant concentrate comprising the synergistic dispersant of claim 15, and a solvent.

18. The dispersant concentrate of claim 17, wherein the solvent is selected from the group consisting of N-methyl-2-pyrrolidone, water, toluene, xylene, isopropanol, ethyl acetate, butyl butyrate, and combinations thereof.

19. The dispersant concentrate of claim 17, wherein the synergistic dispersant, is present in an amount from about 10 to about 80 wt %, based on the total weight of the dispersant concentrate.

20. A conductive carbon dispersion comprising the synergistic dispersant of claim 15, a conductive carbon, and a solvent.

21. A conductive carbon dispersion comprising the dispersant concentrate of claim 17, a conductive carbon, and a solvent.

22. The conductive carbon dispersion of claim 20, wherein the conductive carbon is selected from the group consisting of carbon nanotubes, graphene, carbon black, graphite, and combinations thereof.

23. The conductive carbon dispersion of claim 20, wherein the synergistic dispersant, or dispersant concentrate, is present in an amount from about 0.1 to about 6 wt %; the conductive carbon is present in an amount from about 0.5 to about 12 wt %; and the solvent is present in an amount from about 82 to about 99.5 wt %; based on the total weight of the conductive carbon dispersion.

24. The conductive carbon dispersion of claim 20, wherein the solvent is selected from the group consisting of N-methyl-2-pyrrolidone, water, toluene, xylene, isopropanol, ethyl acetate, butyl butyrate, and combinations thereof.

25. An electrode slurry composition for producing a battery positive electrode comprising the conductive carbon dispersion of claim 20, an electrode active material, and a binder.

26. The electrode slurry composition of claim 25, wherein the electrode active material is selected from the group consisting of lithium iron phosphate (LiFePO₄), lithium manganese iron phosphate (LiMnₓFe₍₁₋ₓ₎PO₄), lithium cobalt oxide (LiCoO₂), lithium manganese oxide (LiMn₂O₄), lithium manganese oxide (Li₂MnO₃), lithium nickel manganese cobalt oxide (LiNi_{0.33}Mn_{0.33}Co_{0.33}O₂), lithium nickel manganese cobalt oxide (LiNi_{0.6}Mn_{0.2}Co_{0.2}O₂), and lithium nickel manganese cobalt oxide (LiNi_{0.8}Mn_{0.1}Co_{0.1}O₂); or from the group consisting of a lithium oxide containing one or more metals selected from the group consisting of cobalt, manganese, nickel, and aluminum; a lithium oxide selected from the group consisting of a lithium-manganese-based oxide, LiMnO₂, and LiMn₂O; a lithium-cobalt-based oxide, and LiCoO₂; a lithium-nickel-based oxide and LiNiO₂; a lithium-nickel-manganese-based oxide, LiNi_{1-Y1}Mn_{Y1}O₂ wherein 0<Y1<1, LiNi_{Z1}Mn_{2-Z1}O₄ wherein 0<Z1<2; a lithium-nickel-cobalt-based oxide, LiNi_{1-Y2}Co_{Y2}O₂ wherein 0<Y2<1; a lithium-manganese-cobalt-based oxide, LiCo_{1-Y3}Mn_{Y3}O₂ wherein 0<Y3<1, LiMn_{2-Z2}Co_{Z2}O₄ wherein 0<Z2<2; a lithium-nickel-cobalt-manganese-based oxide, Li(Ni_{P1}Co_{Q1}Mn_{R1})O₂ wherein 0<P1<1, 0<Q1<1, 0<R1<1, P1+Q1+R1=1, Li(Ni_{P2}Co_{Q2}Mn_{R2})O₄ wherein 0<P2<2, 0<Q2<2, 0<R2<2, P2+Q2+R2=2; and a lithium-nickel-cobalt-manganese-other metal (M) oxide, Li(Ni_{P3}Co_{Q3}Mn_{R3}M¹ s)O₂ wherein M¹ is selected from the group consisting of Al, Cu, Fe, V, Cr, Ti, Zr, Zn, Ta, Nb, Mg, B, W and Mo, and P3, Q3, R3, and S are each an atomic fraction of independent elements, and 0<P3<1, 0<Q3<1, 0<R3<1, 0<S<1, P3+Q3+R3+S=1; and combinations thereof.

27. A positive electrode comprising an electrical current collector and a film formed on the electrical current collector, wherein the film is deposited from the electrode slurry composition of claim 25, and the solvent subsequently removed.

28. An electrical storage device comprising the positive electrode of claim 26, a negative electrode, a separator, and an electrolyte.

29. The electrical storage device of claim 28 comprising a cell, a battery, a battery pack, a secondary battery, or a capacitor.

30. The conductive carbon dispersion of claim 20 which has a viscosity (Pa·s) from about 1 to about 80 Paes, and a solids content (wt %) from about 50 to about 80 wt %, at a shear rate (1/s) from about 0.1 to about 100 1/s; and exhibits lower viscosity and/or increased solids content, as compared to a control conductive carbon dispersion having polyvinyl pyrrolidone (PVP) dispersant.

31. The electrode slurry composition of claim 25 which has a viscosity (Pa·s) from about 5 to about 30 Pa·s, and a solids content (wt %) from about 50 to about 80 wt %, at a shear rate (1/s) from about 0.1 to about 100 1/s; and exhibits lower viscosity, as compared to a control electrode slurry formulation having polyvinyl pyrrolidone (PVP) dispersant, at high solid content.
